(19) United States
(12) Patent Application Publication
(10) Pub. No.: US 2023/0327850 A1
(43) Pub. Date: Oct. 12, 2023

(54) Distributed, Private, Sparse Histograms in the Two-Server Model

(71) Applicant: Google LLC, Mountain View, CA (US)

(72) Inventors: Badih Ghazi, San Jose, CA (US); Shanmugasundaram Ravikumar, Piedmont, CA (US); Pasin Manurangsi, Bangkok (TH); Mariana Petrova Raykova, New York, NY (US); Adrian Gascon, New York, NY (US); James Henry Bell, London (GB); Phillipp Schoppmann, Berlin (DE)

(21) Appl. No.: 18/297,084

(22) Filed: Apr. 7, 2023

Related U.S. Application Data
(60) Provisional application No. 63/328,587, filed on Apr. 7, 2022.

(51) Int. Cl. H04L 9/00; H04L 9/14; H04L 9/06

(52) U.S. Cl. CPC H04L 9/008; H04L 9/14; H04L 9/0643; H04L 2209/46

(57) ABSTRACT

Provided are systems and methods for the computation of sparse, (ε, δ)-differentially private (DP) histograms in the two-server model of secure multi-party computation (MPC). Example protocols enable two semi-honest non-colluding servers to compute histograms over the data held by multiple users, while only learning a private view of the data.

### RELATED APPLICATIONS

This application claims priority to and the benefit of U.S. Provisional Patent Application No. 63/328,587 filed Apr. 7, 2022. U.S. Provisional Patent Application No. 63/328,587 is hereby incorporated by reference in its entirety.

### FIELD

The present disclosure relates generally to systems and methods which enable aggregation of data in a private manner. More particularly, the present disclosure relates to computation of sparse, (ε, δ)-differentially private (DP) histograms in the two-server model of secure multi-party computation (MPC).

### BACKGROUND

Aggregate statistics computed over large amounts of reported data (e.g., from users) are widely used to discover general trends in the reported data. Applications can be found in many different contexts including product analysis and browser telemetry, understanding the spread of viruses, and detecting distributed attacks and fraud behavior. Designing privacy-preserving techniques for computing such analytics with high accuracy while protecting the privacy of individual users has been an active research topic.

The notion of differential privacy (DP) formalizes the guarantee that the output of an algorithm does not reveal substantial information about individual user contributions. The techniques for achieving DP inject noise during the computation, which also affects the accuracy of the output. Central DP mechanisms provide the best known trade-off between privacy guarantees and accuracy. However, they rely on the strong assumption of the existence of a trusted curator that has access to the entire dataset. The local DP setting alleviates the privacy implications of the central curator by distributing the privacy mechanism to the clients, which however comes at a high cost in accuracy.

Secure multiparty computation (MPC) offers techniques that allow two or more parties to jointly compute a function that depends on their private inputs, while revealing nothing beyond the function output during the computation. A natural idea for achieving strong privacy and high accuracy in a distributed setting is to use MPC to execute central DP mechanisms. However, applying this idea directly to compute aggregate user statistics would require executing a multi-round protocol across the devices of all users whose data is included in the aggregate statistics. Given the high computation and communication overhead of existing large-scale MPC implementations, and the unpredictable availability patterns of client devices, this approach becomes challenging with user populations of hundreds of millions or billions.

An intermediate trust model, which avoids a central aggregator and the scalability challenges of fully distributed MPC, is the outsourced MPC model. Here, the functionality of the aggregator is split across a small number of non-colluding parties. These receive secret-shared (or encrypted) inputs from the clients, and then compute the desired aggregate statistics using an MPC protocol between them. As long as at least one of the parties remains honest, the clients' inputs remain private and only the desired aggregate is revealed. Apart from a lower communication and computation overhead, the outsourced MPC model can handle client drop-outs, since usually only a single message from each client is required.

Additionally, in the particular case of two computing parties, aka the two-server model, the MPC protocol can be optimized with the help of the clients. The two-server model has been successfully applied to multiple large MPC deployments. While honest-majority protocols with a larger number of parties can result in better efficiency, it remains challenging to ensure that the honest-majority assumption indeed holds. On the other hand, dishonest-majority MPC protocols for more than two parties suffer from performance drawbacks compared to their two-party counterparts.

Many popular aggregation functions can be described by histograms over user data. Here, each user has a single value from a domain D, and the goal is to compute the number of users holding each possible input value. In many settings, the domain D of the user contributions is much larger than the actual number of unique values among the inputs, and in some settings it is also larger than the total number of users. Hence, the resulting histograms will often be sparse, i.e., most values in the domain will have a count of zero. Examples include the computation of heavy hitters among strings held by the users, finding commuter patterns in location data, or spatial decompositions.

In the case of sparse histograms the question of computational efficiency becomes even more pronounced—ideally, protocols should achieve computation and communication complexities that are independent of the domain size |D| and only depend on the number of contributions that need to be processed. The first question to answer in the search for such a protocol is if there is a central DP mechanism that has output length and computation cost that are independent of |D|. While mechanisms that add DP noise to every possible entry in the histogram do not satisfy this property, the work of Korolova et al. (Releasing Search Queries and Clicks Privately. In Proceedings of the 18th International Conference on World Wide Web (WWW '09)) provides such a solution by guaranteeing that zero counts are always (implicitly) reported as zeros and only a subset of the non-empty histogram locations are reported.

Leveraging existing MPC techniques to realize the central DP mechanism of Korolova et al. comes with a set of challenges. Clearly, techniques that require the client to send inputs proportional to |D| are undesirable. Distributed point functions compress the client computation and communication to O(log |D|), and can be used as frequency oracles to discover non-zero locations in the sparse histogram. This approach, however, will incur an error due to DP that is also O(log |D|), which is worse than Korolova et al. Thus, to date, there is no efficient DP protocol for computing sparse histograms that achieves an error independent of |D|, without relying on a trusted curator.

### SUMMARY

Aspects and advantages of embodiments of the present disclosure will be set forth in part in the following description, or can be learned from the description, or can be learned through practice of the embodiments.

One example aspect is directed to a client computing device configured to perform client operations to enable private and secure multi-party computation. The client operations include obtaining a data entry comprising an index and a value. The client operations include homomorphically encrypting the value using a public homomorphic encryption key to generate a first encrypted value. A private homomorphic encryption key that corresponds to the public homomorphic encryption key is held by a first server computing system. The client operations include encrypting the index and the first encrypted value with one or more second public keys to generate a ciphertext. One or more second private keys that correspond to the one or more second public keys are held by a second, different server computing system. The client operations include transmitting the ciphertext to the first server computing system for collaborative aggregation by the first server computing system and the second computing system.

In some implementations, the client operations further comprise, prior to said encrypting: hashing the index to generate a hashed index. In some implementations, said encrypting the index with the one or more second public keys comprises: encrypting the hashed index using a first semantic public key to generate a first ciphertext component; and encrypting the index using a combined public key to generate a second ciphertext component, wherein the combined public key comprises a combination of two or more public keys that have private counterparts respectively separately held by the first server computing system and the second server computing system.

Another example aspect of the present disclosure is directed to a first server computing system comprising one or more server computing devices, the first server computing system configured to perform first server system operations to enable private and secure multi-party computation. The first server system operations include receiving a respective ciphertext from each of a plurality of client devices. Each ciphertext comprises: a value that has been encrypted using both: a public homomorphic encryption key associated with the first server computing system; and an additional public key associated with a second, different server computing system. The first server system operations include computing a respective pseudoindex for each ciphertext and inserting the respective pseudoindex into the ciphertext. The first server system operations include transmitting the modified ciphertexts to the second server computing system for the second server computing system to compute homomorphic aggregation of the encrypted values partitioned on the basis of pseudoindex. The first server system operations include receiving a set of aggregated values from the second server computing system. The first server system operations include using a private homomorphic encryption key that corresponds to the public homomorphic encryption key to decrypt the set of aggregated values to generate a set of decrypted, aggregated values.

In some implementations, the first server computing system can be referred to as a decryption server computing system and the first server computing system can be referred to as an aggregation server computing system.

In some implementations, the respective ciphertext received from each of the plurality of client devices further comprises a respective first ciphertext component, the first ciphertext component comprising a hashed version of the index that has been encrypted using a semantic public key associated with the second server computing system. In some implementations, computing the respective pseudoindex for each ciphertext comprises computing the pseudoindex from the first ciphertext component using a hash function and key held by the first server computing system.

In some implementations, the respective ciphertext received from each of the plurality of client devices further comprises a respective index that has been encrypted using a combined public key generated from two or more private keys respectively separately held by the first server computing system and the second server computing system. In some implementations, each of the set of aggregated values received from the second server computing system has a respective partially decrypted index associated therewith, each partially decrypted index having been generated by the second server computing system using the respective private key separately held by the second server computing system. In some implementations, for at least one of the set of aggregated values, the first server operations further comprise: further decrypting the corresponding partially decrypted index using the respective private key separately held by the first server computing system to recover the original respective index.

In some implementations, the first sever system operations further comprise, prior to transmitting the modified ciphertexts to the second server computing system: generating one or more dummy contributions; and inserting the dummy contributions into the modified ciphertexts.

In some implementations, generating the one or more dummy contributions comprises: sampling one or more frequency dummy contributions; sampling one or more duplicate dummy contributions; and sampling one or more blanket dummy contributions.

In some implementations, the second server computing system has added noise to one or more of the set of aggregated values.

In some implementations, the first sever system operations further comprise, after decrypting the set of aggregated values to generate the set of decrypted, aggregated values: adding noise to one or more of the set of decrypted, aggregated values.

In some implementations, the first sever system operations further comprise, after decrypting the set of aggregated values to generate the set of decrypted, aggregated values: thresholding the set of decrypted, aggregated values, wherein thresholding the set of decrypted, aggregated values comprises removing one or more of the set of decrypted, aggregated values that is less than a threshold value.

In some implementations, the set of aggregated values have been shuffled by the second server computing system. In some implementations, the first sever system operations further comprise, after decrypting the set of aggregated values to generate the set of decrypted, aggregated values: transmitting the set of decrypted, aggregated values to the second server computing system for de-shuffling by the second server computing system.

In some implementations, the first sever system operations further comprise, after decrypting the set of aggregated values to generate the set of decrypted, aggregated values: receiving a non-zero index decryption list from the second server computing system; and recovering a respective index associated with each entry on the non-zero index decryption list.

Another example aspect of the present disclosure is directed to a second server computing system comprising one or more server computing devices, the second server computing system configured to perform second server system operations to enable private and secure multi-party computation. The second server system operations include receiving a plurality of modified ciphertexts from a first, different server computing system. Each modified ciphertext comprising: a pseudoindex generated by the first server computing system; and a value that has been encrypted using both: a public homomorphic encryption key associated with the first server computing system; and an additional public key associated with the server computing system. The second server system operations include decrypting the respective value in each modified ciphertext using a private key associated with the additional public key to obtain a partially decrypted value for each ciphertext. The second server system operations include partitioning the modified ciphertexts based on the pseudoindices. The second server system operations include determining, for each pseudoindex and using homomorphic aggregation, an aggregated value to generate a set of aggregated values. The second server system operations include transmitting the set of aggregated values to the first server computing system for the first server computing system to decrypt using a private homomorphic encryption key that corresponds to the public homomorphic encryption key.

In some implementations, the first server computing system can be referred to as a decryption server computing system and the first server computing system can be referred to as an aggregation server computing system.

In some implementations, each modified ciphertext further comprises a respective index that has been encrypted using a combined public key generated from two or more private keys respectively separately held by the first server computing system and the second server computing system. In some implementations, the second server system operations further comprise: using the respective private key separately held by the second server computing system to partially decrypt the respective index and generate a respective partially decrypted index; and for at least one of the set of aggregated values, transmitting the corresponding partially decrypted index to the first server computing system for the first server computing system to use the respective private key separately held by the first server computing system to recover the original respective index from the partially decrypted index.

In some implementations, each pseudoindex was generated by the first server computing system from a first ciphertext component using a hash function and key held by the first server computing system, the first ciphertext component comprising a hashed version of the index that has been encrypted using a semantic public key associated with the second server computing system. In some implementations, the second server system operations further comprise, prior to partitioning the modified ciphertexts based on the pseudoindex: partially decrypting each pseudoindex using a semantic private key that corresponds to the semantic public key, wherein said partitioning is performed based on the partially decrypted pseudoindices.

In some implementations, the second server system operations further comprise, prior to transmitting the set of aggregated values to the first server computing system: adding noise to the set of aggregated values.

In some implementations, the second server system operations further comprise, prior to transmitting the set of aggregated values to the first server computing system: adding one or more dummy records to the set of aggregated values.

In some implementations, the second server system operations further comprise: shuffling the set of aggregated values prior to transmitting the set of aggregated values to the first server computing system; receiving a set of decrypted, aggregated values from the first server computing system, the set of decrypted, aggregated values having an ordering that corresponds to the set of aggregated values; and de-shuffling the set of decrypted, aggregated values.

In some implementations, the second server system operations further comprise: generating a non-zero index decryption list that indicates which partially decrypted indices have non-zero values; and transmitting the non-zero index decryption list to the first server computing system.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example computing system according to example embodiments of the present disclosure.

FIG. 2 depicts an example protocol for secure and private aggregation according to example embodiments of the present disclosure.

FIG. 3A-D depict an example protocol for secure and private aggregation according to example embodiments of the present disclosure.

### DETAILED DESCRIPTION

Generally, the present disclosure is directed to the computation of sparse, (ε, δ)-differentially private (DP) histograms in the two-server model of secure multi-party computation (MPC). The present disclosure provides protocols that enable two semi-honest non-colluding servers to compute histograms over the data held by multiple users, while only learning a private view of the data. One proposed solution achieves the same asymptotic [symbol] _{∞}-error of

$$O ( \frac{log ( 1 / δ )}{ε} )$$

as central DP, without relying on a trusted curator. The server communication and computation costs of certain proposed protocols are independent of the number of histogram buckets, and are linear in the number of users, while the client cost is independent of the number of users, ε, and δ. The linear dependence on the number of users lets the protocol scale very well, which has been confirm using microbenchmarks: for a billion users, ε=0.5, and δ=10⁻¹², the per-user cost of an example implementation of the protocol was only 1.18 ms of server computation and 270 bytes of communication. In contrast, a baseline protocol using garbled circuits only allows up to 106 users, where it requires 600 KB per user. Thus, the proposed techniques consume fewer computational resources relative to certain baseline protocols such as garbled circuits, while still providing strong privacy guarantees.

More particularly, example aspects of the present disclosure provide distributed protocols for computing sparse histograms that leverage two non-colluding servers. Some example protocols provided herein require constant one-shot communication from the clients, and the communication between the two servers is linear in the number of contributions from the clients. It provides (∈, δ)-DP for the output with [symbol] _{∞}-error of

$$O ( \frac{log ( 1 / δ )}{ε} ) ,$$

which matches the best possible bound in the central DP model.

Example protocols provided herein guarantee that the output is DP; furthermore, they also guarantee that the view of each server satisfies a computational version of DP called SIM+−CDP (Mironov et al., Computational Differential Privacy. In Advances in Cryptology—CRYPTO 2009, Shai Halevi (Ed.)). Unlike previous work on distributed DP protocols, however, the present disclosure explicitly specifies the DP leakage that is revealed during the protocol execution. This enables comparisons of different approaches beyond the guarantees of DP, and in particular allows distinguishing pure MPC solutions from protocols revealing additional information.

A central aspect of the proposed solution is a reduction from the problem of computing DP histograms over large (exponential-sized) domains in a distributed manner to the problem of computing anonymous histograms over small domains proportional to the number of non-zeros in the output histogram. To achieve this, example approaches leverage cryptographic techniques for distributed evaluation of oblivious pseudorandom functions (OPRFs), which enable the two computing parties to transform the indices from the histogram domain to a pseudorandom domain that allows aggregation while hiding the actual values.

Another example aspect is directed to new distributed DP protocols for computing anonymous histograms, where the servers do not have access to the indices of the inputs in the clear. A first example technique relies on duplication and rerandomization of ciphertexts, and a second alternative technique builds on a secure two-server implementation of a heavy-hitters.

Example experimental results show that the proposed protocols scale well with increasing numbers of parties, due to their linear complexity in the number of inputs. For a billion users, an example implementation can compute a DP histogram using just 1.18 ms of total server computation, and 270 bytes of communication between the servers per user. At the same time, each user only needs to perform 0.46 ms of computation and communicate 192 bytes in a single message.

Thus, the present disclosure provides a number of technical effects and benefits. As one example technical effect, the present disclosure enables aggregation of data with improved privacy. For example, data can be aggregated with privacy guarantees that are equivalent to those offered by a central model. This is an improvement over existing distributed systems and further does not require a trusted curator. Thus, the performance of a computing system is improved. The privacy with which data can be aggregated in a distributed model is improved.

As another example technical effect, the present disclosure enables private aggregation of data with improved computational efficiency. For example, the computational costs can scale linearly with the number of client devices. This is in contrast to previous approaches which scaled super-linearly (e.g., logarithmically). Thus, data can be aggregated with using fewer computational requirements, thereby conserving computational resources such as processor cycles, memory space, network bandwidth, etc.

With reference now to the Figures, example embodiments of the present disclosure will be discussed in further detail.

### Example Preliminaries and Notation

Example Privacy Discussion

Example descriptions herein use supp( [symbol] ) to denote the support of a distribution [symbol] . Example descriptions herein use [symbol] (x) to denote the probability mass of [symbol] at x. For k∈ [symbol] , example descriptions herein write [symbol] ^{åk} to denote the distribution of the sum of k independent samples from [symbol] , i.e., the k-wise convolution of [symbol] . For convenience, example descriptions herein write a+ [symbol] for some a∈ [symbol] to denote the distribution of a+X where X˜ [symbol] . Example descriptions herein also sometimes write a random variable in place of its distribution and vice versa.

The ε-hockey stick divergence between distributions [symbol] , [symbol] ′ is

$${d}_{ε} ( \vert \vert {′}^{} ) := {\sum }_{x ∈ supp ( )} {[ {p}_{} ( x ) - {e}^{ε} \cdot {p}_{{′}^{}} ( x ) ]}_{+} ,$$

where [y]₊: =max{y, 0}.

Example descriptions herein hold that two distributions [symbol] , [symbol] ′ are (ε, δ)-indistinguishable, denoted by [symbol] ≡_{ε,δ} [symbol] ′, iff d_{ε}( [symbol] ∥ [symbol] ′), d_{ε}( [symbol] ′∥ [symbol] )≤δ. Example implementations consider two datasets X, X′ to be neighboring if X′ results from changing a single user's contribution in X.

Differential privacy. A function ƒ is said to be (ε, δ)-differentially private (or (ε, δ)-DP) if, for every pair of neighboring datasets X, X′ it holds that, ƒ(X)≡_{ε,δ} ƒ(X′).

The above neighboring notion is referred to in the literature as substitution DP. Example descriptions herein will as part of the proof make use of the notion of add/remove DP. This is defined by saying X′ neighbors X if one is reached from the other by removing a single user. Example implementations use the fact that add/remove DP implies substitution DP. However example implementations do not provide an add/remove DP guarantee for the whole protocol as the view of a server in an example protocol proposed herein includes the number of users.

Example descriptions herein use the following probability distribution families. The Poisson distribution, denoted Poi(q), is the discrete non-negative distribution with mass function exp(−η)η^{x}/x!. The negative binomial distribution, denoted NBin(r,p), is the discrete non-negative distribution with mass function given by

$$( \begin{matrix}x + r - 1 \\ x\end{matrix} ) {( 1 - p )}^{r} {p}^{x} .$$

The discrete Laplace distribution, denoted D Lap(λ), is the discrete distribution with mass function ∝exp (−|x|/λ). Example implementations will use the (discrete) Laplace Mechanism, i.e., the fact that adding a noise sample from DLap(λ), with λ=Δ/ε, to the result of a sensitivity-Δ (discrete) query provides (ε, 0)-DP. The truncated discrete Laplace distribution, denoted TDLap(λ, t), is the discrete distribution on {−t, . . . , t} with mass function ∝exp(−|x|/λ). Example implementations use the fact that adding a noise sample from TDLap(λ, t), with λ=Δ/ε, to the result of a sensitivity Δ query provides (ε, 2e^{-(t-Δ)ε/Δ})-DP. This follows from the following tail bound, which example implementations use as follows: for X˜D Lap(λ), it holds that Pr[|X|≥sλ]≤2e^{-s}. Thus, setting t=┌Δ+Δ/ε log(2/δ)┐ provides (ε, δ)-DP. Example implementations can use this mechanism in situations where bounded noise samples are used. The truncated shifted discrete Laplace distribution, denoted TSDLap(λ, t), is the discrete distribution on {0, . . . , 2t} with mass function ∝exp(−|x−t|/λ). An analogous result holds in this case: adding a noise sample from TSDLap(λ, t=┌Δ+Δ/ε log(2/δ)┐) to the result of a sensitivity Δ query provides (ε, δ)-DP. Example implementations use this mechanism in situations where positive noise samples are used.

Example Security Discussion

Homomorphic encryption. Homomorphic encryption (HE) is a primitive that allows computation on encrypted data. In our construction example implementations only use additive HE schemes with function secrecy, denoted by AHE. Some example implementations use ElGamal encryption in its additively-homomorphic variant.

Garbled circuits. Garbled circuits are a generic approach for secure two-party computation that enables the secure evaluation of any function that can be represented by a Boolean circuit. This a one-round protocol where one of the parties, the garbler, prepares an encoding of the evaluated circuit referred to as a garbled circuit (GC) and sends it to the other party, the evaluator, which can only evaluate the GC on a set of inputs for which it has the corresponding garbled encodings. The garbler provides the encodings of its own input and the parties run a protocol to enable the evaluator to obtain the encodings for its input.

Oblivious pseudorandom function (OPRF). A pseudorandom function (PRF) is a keyed function F_{K} such that the output F_{K}(x) is indistinguishable from random even when the input x is known, as long as the key K is secret. An oblivious PRF is a PRF that has a mechanism for evaluating it such that the party holding the key K does not learn the input x, and the party providing the input x learns F_{K}(x).

Some example implementations of the present disclosure use the PRF F_{K} (x)=H(X)^{K}, where this function is pseudorandom when H is modeled as a random oracle.

Example Setting & Threat Model

One example objective of example implementations of the present disclosure is to compute a DP histogram over inputs held by many clients, without trusting any single party. Example implementations achieve this by distributing trust across two servers, and having them compute the histogram using an interactive secure computation protocol. The servers are assumed to be semi-honest, i.e., they follow the steps of the protocol and in addition, are non-colluding and do not share or receive any information with each other.

Some example implementations can provide outputs that are guaranteed (ε, δ)-DP. However, since the original definition of DP assumes a central, trusted curator, it does not immediately generalize to multiple parties. One way to extend the notion of DP to the multi-party setting is by requiring that the views of each subset of parties corrupted by an adversary be DP. Another concept in the art is computational DP (CDP), which allows for a computationally bounded adversary. Another privacy notion in the art, SIM⁺-CDP, requires that the protocol in question securely implements (in the ideal/real simulation paradigm of MPC) a functionality that in turn provides DP. What this means is that the distributed execution of the MPC protocol does not reveal to any of the parties anything more than the output of the computation, which also provides DP properties. This is a stronger guarantee than only requiring that the view of each party during the execution is DP.

In the MPC literature, multiple works explore the notion of DP leakage. This relaxes the regular MPC guarantee where no party can learn anything other than the output, by allowing the participants to learn additional information, but imposing the requirement that this additional information provided is DP. Formally, this is modeled by capturing the additional information revealed during the protocol execution as a leakage term, which is provided to the simulator used in the security proof. This allows comparing different protocols for the same functionality in terms of their leakage, which can vastly differ. In particular, it allows a more fine-grained control over the information leaked, beyond DP.

Example implementations follow the same paradigm for certain security definitions and require protocols to explicitly define their leakage [symbol] that gets revealed in the ideal-world functionality together with the output. A protocol implementing functionality [symbol] is secure with leakage [symbol] , if it computes [symbol] and the view can be simulated from ( [symbol] , [symbol] ). Example implementations require that [symbol] and [symbol] be jointly defined so as to define their joint distribution in a function [symbol] .

[View] Let Π be a two-party protocol with inputs from X₁×X₂. Then View_{b}^{Π}(x₁, x₂) denotes the view of party b during the execution of Π with inputs x₁ ∈X₁ from P1 and x₂ ∈X₂ from P2. The view includes all messages received, as well as all random numbers sampled during the execution.

[Functionality with leakage] Let [symbol] =( [symbol] ₁, [symbol] ₂)=(( [symbol] ₁, [symbol] ₁), ( [symbol] ₂, [symbol] ₂)) be a two-party functionality from X₁×X₂. Let [symbol] =( [symbol] ₁, [symbol] ₂) and [symbol] =( [symbol] ₁, [symbol] ₂). Example implementations say that a two-party protocol Π securely implements [symbol] with leakage [symbol] , if for each b∈{1,2} there exists a probabilistic polynomial-time algorithm Sim_{b} such that for all x₁∈X₁, x₂∈X₂, the output of (Sim_{b}(x_{b}, [symbol] _{b}(x₁,x₂)), [symbol] (x₁,x₂)) is computationally indistinguishable from (View_{b}^{Π}(x₁,x₂),Π(x₁, x₂)). Example descriptions herein call [symbol] the functionality with leakage.

Note that this definition does not require the leakage to be explicitly computed by Π, which would be required if a secure computation of [symbol] was required. This also means however the possibility that learning [symbol] ₁ and [symbol] ₂ together might leak too much about the output. For this reason some example implementations require that the party not colluding with the adversary does nothing to reveal their leakage to the other party. This includes through any further actions taken. Some example implementations do however allow, as in classical MPC, each party to share their output with the other party, or use it in subsequent computations.

Let Π[X]₀, [X]₁)→(Y₀, Y₁) be a protocol that is executed between party P1 with input [X]₀ and P2 with input [X]₁, and that outputs Y₀ to P1 and Y₁ to P2. Let View_{Π} be the set of messages exchanged between the two parties in the protocol. Let [symbol] ₀ and [symbol] ₁ be defined as a DP function of [X]₀, [X]₁. Example descriptions herein say that Π is [symbol] -secure if there exist probabilistic polynomial-time algorithms Sim_{b}(Y_{b}, [symbol] _{b},[X]_{b}) that output message distributions View_{Sim}_{_{b}} such that View_{Sim}_{_{b}} and View_{Π} are computationally indistinguishable for b∈{0,1}.

Let [symbol] :X×X→Y×Y and [symbol] :X×X→Y×Y be probabilistic, possibly correlated, two-party functionalities. Example descriptions herein say that a two-party protocol Π securely implements [symbol] with leakage [symbol] , if there is a two-party functionality [symbol] such that for any x₁, x₂ ∈X, [symbol] (x₁, x₂)=( [symbol] (x₁, x₂), [symbol] (x₁, x₂)), and Π securely implements [symbol] .

Malicious clients. While one example focus of the present disclosure is constructing a distributed aggregation protocol that protects the privacy of the contributing clients, another example concern for practical deployments might be malicious clients who provide incorrect inputs that skew the output and render it useless, or collude with one of the two servers to reveal the values of honest clients. Therefore, some example approaches in such a setting aim to limit the clients' contributions to some allowable range by adding zero-knowledge proofs from the clients that allow the aggregators to verify the clients' inputs are valid without learning any further information.

### Example Target Functionality & Baselines

Some example implementations of the present disclosure aim to implement a distributed version of a mechanism which can be referred to as a stability-based histogram. Given a dataset [symbol] =(indᵢ)_{i∈[n]} of indices from a large domain D, the mechanism (i) builds a histogram [symbol] of [symbol] , (ii) adds DLap(2/ε) noise to each of the non-zero entries of [symbol] , (iii) removes the entries whose value is below a threshold τ=2 log(2/δ)/ε, and (iv) releases the resulting histogram. The threshold is chosen so that the probability of releasing an index with true count 1 is bounded by δ. The variant where each client might contribute a larger value valᵢ ∈[1, . . . , Δ] to indᵢ, and thus the input is a set [symbol] =(indᵢ, valᵢ)_{i∈[n]} can be easily handled by adding DLap(2Δ/ε) noise and setting τ=Δ+2Δ log(2/δ)/ε.

Example Generic MPC Solution

One direct solution is to apply generic two-party computation (2PC) between the two servers for the central DP mechanism described above. Clients secret-share their input across the two servers, and then the servers engage in a generic 2PC, e.g., using garbled circuits, to implement our target functionality described above. Recall that the garbled circuits protocol requires the system to express the computed function as a Boolean circuit. Therefore, using a naive encoding with too many input-dependent operations blows up the circuit size, and thus the computational costs (which are linear in the number of AND gates in the circuit). One data-oblivious algorithm for this target functionality results in a circuit of size P(log|D|·n log n) by relying on well-known sorting/permutation networks of size O(n log n). The properties of the resulting protocol, which example descriptions herein use as a baseline for experimental evaluation, are captured in the following theorem. As mentioned above, a distinctive aspect of the proposed solution is that the server costs are O(n·log(|D|)).

Theorem: Consider n clients each holding a pair indᵢ ∈D, valᵢ ∈[Δ]. There is a one-round secure protocol relying on two non-colluding servers P1, P2 for P1 to obtain a DP histogram of the input data with l_{∞}-error O(Δ log(1/δ)/ε). The communication and computation are O(log|D|·n log n) for the servers, and O(log|D|) for the clients.

Example Discussion of Shuffle DP

Another possible baseline is to use the protocols from the shuffle DP literature. Recall that the shuffle model of DP is an intermediate model between the local and central models of DP, where the client sends messages to a trusted shuffler that randomly permutes the messages of all users together before sending them to the analyzer. The requirement is that the view of the analyzer (or equivalently the multiset of messages) needs to be DP. It is possible to instantiate the Shuffle DP model in a two-server setting by implementing secure shuffling (e.g., via onion shuffling).

Histogram queries are well-studied in the shuffle model. Unfortunately, while it is known that an error of O_{ε}(log(1/δ)) is achievable, known protocols suffer from communication complexity that grows with

$${Ω}_{ε} ( \frac{\vert D \vert}{n} \sqrt{log ( 1 / δ )} )$$

where |D| denotes the domain size. This is prohibitively large in our setting of interest where |D|>>n; therefore, example implementations cannot use this as a baseline in our experiments.

### Example Technical Overview

Recall that the input to one example problem solved by the present disclosure is a set {(indᵢ, valᵢ)}_{i∈[n]} of client-held (index, value) pairs.

As mentioned above, an example protocol proposed herein leaks a DP view of the input data to each of the non-colluding servers. Intuitively, the example protocol reveals, besides the output, a DP anonymized histogram of {indᵢ}_{i∈[n]} to one of the servers, and a DP anonymized histogram of {valᵢ}_{i∈[n]} to the other one. Recall that an anonymized histogram corresponds to the number of values occurring i times, for every i>0. The privacy of individuals' input (as well as that of small groups) are thus protected in the precise sense of DP, while protecting the input as a whole (in the sense of standard simulation-based MPC) is sacrificed in favor of efficiency, as discussed above.

Example Protocol Description

Outline of example protocol steps. A high-level description of one example protocol involves four steps of interaction between the servers P1 and P2, as outlined below.

Step (1): Clients submit an encrypted report to P1, constituting a set [symbol] ⁽¹⁾ of ciphertexts, encrypted under keys held by P2—the values are encrypted directly while the indices are hashed and then encrypted. Due to the properties of the (ElGamal) encryption, P1 can manipulate the encrypted reports in [symbol] ⁽¹⁾ to homomorphically, i.e., without prior decryption, (i) randomize the hashed index H(ind₁) into a pseudoindex H(indᵢ)^{K}, generated under a key K held by P1, and (ii) duplicate and rerandomize encryptions.

Step (2): Using these two operations as well as simulating additional dummy contributions, P1 constructs a set [symbol] ⁽²⁾ of encryptions of (pseudoindex, value) pairs that contains the original set of client contributions. The second component is encrypted under an AHE scheme for which P1 has the key and then additionally with a layer of semantically secure encryption for which P2 has the key, which protects the values from P1. P1 sends [symbol] ⁽²⁾ to P2 in a random order. Dummy contributions in [symbol] ⁽²⁾ are given a value of 0 so that they do not affect the final histogram estimate.

Step (3): P2 decrypts the ciphertexts in [symbol] ⁽²⁾, and groups them by their first component. Note that this only reveals the multiplicity of each index, as the indices are pseudorandom (they are encoded as H(indᵢ)^{K}) and the values are encrypted. P2 then adds up values homomorphically, and returns the resulting set of values to P1, along with a random number of dummy encryptions of values in [Δ] (plus Laplace noise) in a random order; let [symbol] ⁽³⁾ be this set. The purpose of the dummy values is to ensure that P1 can decrypt the values homomorphically aggregated by P1 and threshold them (with threshold r) in the clear, while preserving DP.

Step (4): Pseudoindices are inverted and P1 learns the histogram.

The above description is a slight simplification as some example implementations cannot “invert” the pseudoindices. Instead, each client also sends an encryption of its index encrypted under the keys of both P1, P2 (e.g., denoted by bᵢ); these encrypted indices are passed around together with the aforementioned pseudoindices and values, and only fully decrypted for the indices that pass the threshold.

Dummy contributions and DP. Note that there are two steps where dummy contributions are injected: step (2) and step (3). In both cases the distributions for the dummy contributions are carefully chosen to ensure that the amount the other party can learn about the input, observing the traffic in the respective steps, is bounded in the sense of DP. This results in a trade-off between computation/communication costs and privacy.

Concretely, in step (3) P2 learns an anonymized histogram (aka histogram of a histogram) of the set {indᵢ}_{i∈[N]} of indices in the input, which is defined as the histogram [symbol] whose ith entry [symbol] ᵢ contains the number of indices with multiplicity i in the input. But, this is leaky since [symbol] ⁽²⁾ reveals the multiplicity of each of the indices in the input. Unfortunately, this makes some of the example protocols proposed herein not DP (e.g., if the adversary knows all-but-one of the indices, then it can infer from [symbol] with certainty if the remaining index coincides with its known indices.)

As mentioned above, some example implementations can overcome this issue by having P1 insert dummy contributions in [symbol] ⁽²⁾, in addition to the ones corresponding to the input. As explained below, a careful selection of the distribution of the dummy contributions ensures that [symbol] ⁽²⁾ now only leaks a DP anonymized histogram. Note that the situation in step (3) is analogous, as in that case P2 inserts dummy contributions to ensure DP of P1's view of the protocol. A core challenge of this approach is in balancing the trade-off between privacy and communication: dummy contributions help provide meaningful DP protection but can blow-up communication. An example component of one example proposed solution is a mechanism for doing this efficiently, which are described next. The description builds up to example solutions by starting with a simpler, less efficient approach and progressing to more sophisticated, efficient ones.

Example Anonymous Histograms Via Duplication

This section presents two different example protocols to achieve DP under complementary assumptions on the input distribution. An example hybrid protocol will correspond to running these two protocols sequentially.)

More specifically, for a threshold value T, a first example protocol (per-multiplicity noising) provides DP only to user contributions whose multiplicity is at most T, while a second example protocol, duplication-based noising, protects inputs with multiplicity at least T.

Example per-multiplicity noising: An efficient example protocol for small multiplicities. A standard approach to producing a DP histogram is to add appropriately scaled (discrete) Laplace noise to each of its entries. To implement this idea in our setting, P1 would have to add O_{ε,δ}(D) dummy contributions (O_{ε,δ}(1) many for each possible index). A slight optimization follows from the fact that, since P2 observes an anonymized histogram, it is enough to noise a histogram of multiplicities [symbol] , where [symbol] ᵢ counts the number of pseudoindices with multiplicity i in [symbol] ⁽²⁾. In our setting, P1 can implement this mechanism by adding contributions with dummy indices (from a domain [symbol] disjoint with the original domain); adding i contributions with a single dummy index is equivalent to adding a noise of value one to the i-anonymized histogram entry [symbol] ᵢ. Since [symbol] can have as many as n non-zero entries and the noise has to be added to each entry, P1 needs to add Σ_{i∈[n]} O_{ε,δ}(i)=O_{ε,δ}(n²) different such contributions to ensure that [symbol] ⁽²⁾ is DP. However, if example implementations could assume that no pseudoindex has multiplicity above a threshold T, i.e., that ∀i>T: [symbol] ᵢ=0, then noising up to multiplicity T suffices, and the overhead is O_{ε,δ}(T²); this is clearly undesirable for large T.

Example duplication: An efficient example protocol for large multiplicities. Note that P1 is not limited to simulating dummy contributions: since ElGamal encryption allows for rerandomization, P1 can obliviously produce an encryption of (indᵢ, 0) given an encryption of (indᵢ, valᵢ), learning neither indᵢ nor valᵢ. Example implementations will leverage this “duplication” capability to construct a protocol.

Note the following observation. Consider an input dataset [symbol] and another dataset [symbol] ′ identical to [symbol] except without client 1's data, and the corresponding anonymized histograms [symbol] , [symbol] ′ for the respective set [symbol] ={indᵢ}_{i∈[n]} [symbol] ′={indᵢ}_{i∈[2 . . . n]} of indices. Note that these datasets are neighboring in the add/remove sense. Now, let x be the multiplicity of indᵢ in [symbol] , and note that [symbol] , [symbol] ′ differ only in two adjacent entries x, x−1, as removing indᵢ from [symbol] reduces the number of indices with multiplicity x by one, while increasing the number of indices with multiplicity x−1 by one. More precisely, it holds that [symbol] ₓ= [symbol] ′ₓ+1, [symbol] ₓ₋₁= [symbol] ′ₓ₋₁−1, and ∀y∈{x, x−1}, [symbol] _{y}= [symbol] ′_{y}. (Note that this is less general than a histogram where changes with respect to a neighboring dataset can happen in arbitrary buckets, although the [symbol] ₁ sensitivity is bounded by 2 in both cases.)

Consider how [symbol] changes when example implementations duplicate each index in [symbol] a random number of times sampled from a distribution [symbol] . This is described in the following example algorithm Dup ( [symbol] ), which returns the modified histogram [symbol] ^{d} given [symbol] :

```
Dup( [symbol]  ): [symbol]
^{d} = Ø [symbol]    Emptyhistogram
  For y ϵ Dom( [symbol]  )
    Repeat [symbol]   _{y} times
      Sample a~ [symbol] [symbol]
      _{y+a}^{d} ← [symbol]   _{y+a}^{d} + 1
Return [symbol]   ^{d}
```

Note that the example algorithm iterates over each entry y of the original histogram [symbol] “shifting” each of the contributions to entry y by a˜ [symbol] entries. Thus, a corresponds to the total number of additional copies of an index with multiplicity y, where each of its y instances is duplicated X˜ [symbol] times.

To satisfy DP, [symbol] can be chosen so that Dup( [symbol] )≡_{ε,δ} Dup ( [symbol] ′). Since [symbol] and [symbol] differ by one in entries x−1 and x, and are equal elsewhere, this boils down to the property that aₓ₋₁≡_{ε,δ}1+aₓ, where aₓ₋₁˜ [symbol] , aₓ˜ [symbol] . This is almost the same as the condition for the mechanism that adds [symbol] noise to be DP (which just replaces aₓ₋₁˜ [symbol] with aₓ₋₁˜ [symbol] ). Indeed, example implementations show that several well-known distributions [symbol] such as Negative Binomial—which have already been used for DP—satisfy this more stringent condition, assuming that x>T. Note that the latter assumption is necessary: if x=1, then the condition obviously fails as aₓ₋₁=0 always whereas 1+aₓ≥1. To achieve DP, example implementations are required to have aₓ₋₁>0 with at least O_{ε,δ}(1) probability. Hence, the expected number of duplicates required per item is O_{ε,δ}(1/T), yielding a total of O_{ε,δ}(n/T) duplicates.

A example hybrid protocol: Best of both worlds. Example implementations sequentially combine the duplication and per-multiplicity noising protocols to obtain a hybrid protocol. To do that, example implementations first add per-multiplicity noise up to a predefined threshold T, and then apply the duplication protocol to the resulting set. This leaves the task of choosing T. Since one example goal is to minimize the total number of dummy contributions inserted by P1, this boils down to optimizing O_{ε,δ}(T²+n/T) (which in practice example implementations perform numerically), corresponding to the overhead of this hybrid protocol.

The hybrid protocol—instantiated with TSDLap(·) and NBin(·) distributions, respectively—results in a practical protocol, but some example implementations can do better. Next, an optimization is introduced that leads to another example protocol.

An example improved protocol. Notice that once the threshold T is fixed, the hybrid protocol reduces the DP proof to two cases. Let x be, as above, the number of occurrences of the index of the user being protected. If x≤T, then adding Laplace noise provides DP and, if x>T, then the duplication provides DP. Now consider the amount of noise that the hybrid protocol adds for a multiplicity x=T−1, i.e., when x is large, but not large enough to be protected by duplication. In the hybrid protocol, inputs with multiplicity x are protected exclusively by the per-multiplicity noise, even if they get duplicated almost as many times as necessary to achieve DP via duplication. This is unsatisfying as duplication in this case results in “wasted” communication overhead without improving privacy. To tackle this, example implementations can introduce a carefully calibrated Poisson noise to supplement duplication.

At a high-level, example implementations can leverage an intermediate regime (T, T′). For multiplicities up to T, some example implementations can use per-bucket noise; for multiplicities larger than T′, some example implementations can use (appropriately calibrated) duplication. The next discussion describes how to protect inputs with multiplicity in (T, T′).

Let x be a multiplicity in (T, T′). After duplication, the new multiplicity x+ [symbol] ^{åx} is “spread out” in the interval [x, ∞). In particular, this means that adding O_{ε,δ}(j) noise to each multiplicity j∈[x, T′] (as the per-multiplicity noising would do) is an overkill. Instead, that additional O_{ε,δ}(j) noise can be spread out analogously to how x+ [symbol] ^{åx} is spread out. Example implementations achieve that by adding noise to each multiplicity j by a Poi(ηⱼ) amount, where ηⱼ's are carefully chosen parameters. Asymptotically this seems to improve the dependence of the required noise on δ and makes a practical improvement as shown in experiments.

Some example implementations view the supplement Poisson noise as creating (a randomized number of) “clones” of x or x−1. Using properties of Poisson distributions, the number of these clones also follows the Poisson distribution; example implementations show that DP is achieved as long as the expected number of clones is sufficiently large. This condition is then used to select our choice of Ili's both theoretically and numerically in experiments.

Example Anonymized Histograms Via Heavy Hitters

In the above discussion, some example implementations used the duplication method to provide DP for the counts at histogram entries that occur at least T times in the clients' input. This technique was leveraging only the encrypted histogram entries IDs to provide DP without identifying what is the set of entries that have counts larger than T. On the other hand, if the servers are able to identify those entries, then they can directly add the appropriate DP noise with sensitivity one, which would protect the contributions of a single client. (This would indeed be more in line with the aforementioned central DP algorithm.)

Identifying all items that occur with frequency greater than a fixed threshold is the functionality of finding heavy hitters. Therefore, one example solution includes: (i) running a PHH protocols to identify frequent indices (with multiplicities above a threshold T) and (ii) noising the identified indices. These two steps would replace the duplication-based step mentioned above. Example implementations consider this type of approach which, while it reduces the communication cost coming purely from duplications of client contributions, it introduces communication from the secure computation evaluating the distributed PHH protocol. It also consumes from the DP budget for the whole execution to identify the heavy hitters. As a result the approach leveraging PHH as a first step has communication advantage both asymptotically and numerically only in settings with very small constant number of heavy hitters.

### Example Protocols

This section describes example protocols of the present disclosure in more. This discussion splits the target functionality into two parts: first the section describes a thresholding functionality and protocol that allows the two servers to reveal the DP values among a set of encrypted values that pass a certain threshold T. This section then uses that functionality inside a larger example protocol for computing a private histogram.

In the following subsections, the same structure is used: First, the target functionality is described, followed by an example protocol proposed herein. Then, the leakage functionality of an example protocol proposed herein is provided. Then it is shown that an example protocol proposed herein securely implements the target functionality with the given leakage. Finally, it is shown that the output of the combined functionality (target functionality+leakage) provides DP.

Example Target Functionality

[symbol]

```
Public parameters:
Noise parameter s λ, t and threshold τ.
AHE scheme with public key PK₁.
Inputs:
P1: SK₁, the secret key corresponding to PK₁.
P2: Ciphtertexts (wᵢ)_{i∈[n]}, where each wᵢ has the form Enc(PK₁, valᵢ).
Functionality:
(1) For i = 1, . . . , n:
  (a) ξᵢ⁽¹⁾, ξᵢ⁽²⁾ ←_{R} TDLap(λ, t), ξᵢ ← ξᵢ⁽¹⁾ + ξᵢ⁽²⁾
  $( b ) {\overline{val}}_{i} ← \{ \begin{matrix}{val}_{i} + {ξ}_{i} & if {val}_{i} + {ξ}_{i} \geq τ , \\ 0 & otherwise\end{matrix}$
(2) Return (v̅a̅l̅ᵢ)_{i∈[n]} to P1
```

Example Thresholding Protocol

This section describes an thresholding protocol that can be used to implement Steps (4) and (5) introduced above. The inputs of P2 are homomorphically encrypted ciphertexts (wᵢ)_{i∈[n]}, and P1 holds the corresponding secret key. The functionality first, in Step (1a), samples noise from a truncated centered discrete Laplace distribution that is added to each decrypted value. It then, in Step (1b), sets all values that are below the threshold τ to zero. Finally, in Step (2), the thresholded values are returned to both parties.

An example protocol proposed herein for implementing the thresholding functionality is given in the example Protocol ε_{threshold} below. There are two sources of leakage in that protocol. First, each party keeps their own share of the noise value ξᵢ that is added to each entry i∈[n]. This means that the parties can locally compute a version of the output that is less noisy than the ideal functionality output. Therefore, some example implementations have to include each party's respective noise share in the leakage. The second source of leakage comes from the fact that P1 learns all values with only P2's noise added before thresholding.

The following formal description omits the parties' inputs for readability, e.g., the description writes [symbol] _{threshold} P1 to denote [symbol] _{threshold} P1(x₀,x₁).

[Leakage of Π_{threshold}] Let ξᵢ⁽¹⁾, ξᵢ⁽²⁾ be noise samples. Then example implementations define leakages for Π_{threshold}:

[symbol]

_{threshold}P1={(ξᵢ⁽¹⁾)_{i∈[n]},(valᵢ+ξᵢ⁽²⁾)_{i∈[n]}},

[symbol]

_{threshold}P2={ [symbol] }.

The functionality with leakage is defined to be the joint distribution ( [symbol] _{threshold}, [symbol] _{threshold}^{Pi}), denoted [symbol] _{threshold}.

Theorem: The protocol Π_{threshold}, setting λ₁=λ, securely implements [symbol] _{threshold} from [symbol] _{threshold} with the leakage [symbol] _{threshold}=( [symbol] _{threshold}P1, [symbol] _{threshold}P2).

Theorem: Let λ=2Δ/ε and t=Δ+λ log(2/δ). Then, for i∈{1,2}, [symbol] _{threshold}=( [symbol] _{threshold}, [symbol] _{threshold}^{Pi}) is an (ε, δ)-DP function on a database (valⱼ∈[Δ])_{j∈[n]}.

Example Protocol Π_{threshold} that implements [symbol] with leakage [symbol] _{threshold}.

```
  Public Parameters:
    - Noise parameter s λ, t .
    - Threshold τ > 2t.
    - AHE scheme with public key PK₁.
  Inputs:
  P1: SK₁, the secret key corresponding to PK₁.
  P2: Ciphertexts (wᵢ)_{iϵ[n]}, where each wᵢ has the form Enc(PK₁, valᵢ).
  Protocol:
  (1) P2
  Public Parameters:
      (a) For each i ϵ [n], add noise to the encrypted values using the homomorphic
encryption properties: [symbol]
          ⁽¹⁾ ← (Enc(PK₁, valᵢ + ξᵢ)_{iϵ[n]}
where ξᵢ ← TDLap(λ, t).
      (b) Send [symbol]   ⁽¹⁾ to P1.
  (2) P1
      (a) For each record w′ᵢ ϵ [symbol]   ⁽¹⁾ received from P2:
        (i) Decrypt val′ᵢ ← Dec(SK₁, w′ᵢ).
        (ii) Sample ξ′ᵢ ← TDLap(λ, t), and compute val″ᵢ < val′ᵢ + ξ′ᵢ.
        (iii) If val″ᵢ < τ, val″ᵢ ← 0.
      (b) Set [symbol]   ⁽²⁾ ← (val″ᵢ)_{iϵ[n]}.
  (3) P1 outputs [symbol]   ⁽²⁾.
```

Example Target Private Histograms Functionality [symbol] .

```
Public Parameters:
  DP parameters ε, δ, sensitivity Δ.
  Noise parameters λ = 2Δ/ε and t = Δ + λlog(2/δ).
  Threshold τ = A + 2t + 1.
Inputs:
Clients: Index-value pairs (indᵢ, valᵢ)_{i∈[n]}
Functionality:
(1) Let (ind′ⱼ)_{j∈[n′]} denote the unique indices in the input. For each j ∈ [n′]:
  (a) Sample ξⱼ⁽¹⁾, ξⱼ⁽²⁾ ←_{R} TDLap(λ, t).
  (b) Compute ξⱼ ← ξⱼ⁽¹⁾ + ξⱼ⁽²⁾ and
    ${val}_{i ′} = \{ \begin{matrix}⊥ & if {s}_{i} + {ξ}_{i} < τ \\ {s}_{i} + {ξ}_{i} & otherwise\end{matrix} ,$
where sᵢ = Σ_{{j|ind}_{ⱼ}_{=ind′}_{ᵢ}_{}} valⱼ.
(2) Output {(indⱼ^{′}, val_{j′})|j ∈ [n′], valⱼ, ≠ ⊥} to P1
```

Example Private Sparse Histograms

This section describes another example protocol for private sparse histograms. This section gives a formal description of the target functionality in [symbol] ₕᵢₛₜ. It closely follows the high-level description given above, with the main difference being that example implementations explicitly split up the noise terms ξᵢ into two components, one of which is leaked to each helper server through the thresholding protocol from the previous section.

An example protocol of this nature is in Π_{threshold} below. In Step (1), each client i starts by preparing three ciphertexts from its (indᵢ, valᵢ) pair: One containing an encryption of the hash of indᵢ, which is going to be used to obtain an OPRF value for indᵢ. The second encrypts indᵢ (without the hash). This is used to recover the cleartext bucket IDs that pass the threshold after aggregating. Finally, the clients generate homomorphic encryptions of their values, using P1's AHE public key, and then again encrypting the resulting ciphertext under P2's public key using standard encryption. This allows P2 to homomorphically add up client contributions belonging to the same bucket, while hiding the values from P1 until they are aggregated via the outer encryption layer.

In Step (2), P1 exponentiates each first component with its secret PRF key K, to hide the cleartext indices from P2. It then proceeds to add dummy values as discussed elsewhere herein, using encryptions of zero as the third component to ensure the dummies do not add to the aggregated values. Details of example dummy sampling algorithms are provided below. The resulting set of ciphertexts is shuffled and then sent to P2.

P2 can now in Step (3) decrypt two of the three components. After decryption in Step (3a),
h′ᵢ is equal to H(u′ᵢ)^{K},
w′ᵢ is similarly equivalent to Enc_{HE}(PK_{AHE}, v′ᵢ),
   for some index-value pair (u′i, v′i), either contributed by a client, or added by P1 as a dummy.

After decrypting, P2 homomorphically aggregates all third components of triples that share the same first component, choosing one of the second components arbitrarily. Now observe that at this point, the number of aggregate buckets is not differentially private from P1's view, since P1 knows exactly how many dummy buckets were added in Step (O(b)i). To account for this, P2 has to add additional dummy buckets, which is done, e.g., in the call to SampleBuckets in Step (3d). After that, the parties invoke Π_{threshold} on the aggregated values, obtaining the cleartext values above the threshold τ. Example descriptions have set τ to be more than Δ+2t₁ to guarantee that the dummies added by P2 in Step (2a) are always below τ even after adding two TD Lap samples. Note that this can potentially be optimized if example implementations allow dummies to be above the threshold with probability 2^{-σ} for a statistical security parameter σ.

Finally, in Steps (6)-(7), P2 and P1 jointly decrypt the second components corresponding to values above the threshold, which allows P1 to obtain the cleartext indices for those values. Note that some example implementations do this while preventing P2 from linking the decrypted indices to the pseudorandom buckets for which it did aggregation.

Further below, the functionality with leakage, [symbol] ₕᵢₛₜ is defined for an example protocol proposed herein. The definition of [symbol] ₕᵢₛₜ follows Πₕᵢₛₜ. The components of the leakage correspond to the noisy (anonymized) histograms revealed to both parties throughout the protocol, where one party learns the noise samples, and the other learns the noisy histogram. Steps (3)-(5) in [symbol] ₕᵢₛₜ can, e.g., correspond to the call to SampleDummies in Step (2a) of Πₕᵢₛₜ, whereas Step (6) in [symbol] ₕᵢₛₜ can, e.g., correspond to the call to SampleBuckets in Step (3d) of Πₕᵢₛₜ. Note that [symbol] ⁴ is not revealed to P1 directly, but only after adding noise to each entry, as Part of [symbol] _{threshold} P1. Steps (7)-(9) can, e.g., correspond to the call to Π_{threshold} in Step (4) of Πₕᵢₛₜ. Note that all dummy buckets added by P2 in Step (6) will be below τ=Δ+2t₁+1, and so no dummy buckets will appear in [symbol] ₕᵢₛₜ^{P}1. In Step (12) the leakage [symbol] ₕᵢₛₜ to both parties is defined. Note that the output of Π_{threshold} to P2 can be made to be part of the leakage here, since P2 does not have any output in [symbol] ₕᵢₛₜ.

An Example Protocol Πₕᵢₛₜ for Computing Private Histograms.

Public Parameters:

```
  Group [symbol]   of prime order q with generator g.
  Histogram index domain [symbol]   = {0, . . . , 2^{d} − 1}, value domain [symbol]  = {0, . . . , Δ}.
Dummy index domain [symbol]   with [symbol]   ∩ [symbol]   = ∅.
  Random oracle H: [symbol]   ∪ [symbol]   → [symbol]  .
  ElGamal public encryption keys PK = PK₁ · PK₂, PK′ ∈ [symbol]   . Public encryption
key PK_{AHE} for additive homomorphic encryption. Public encryption key for semantically secure
encryption PK″.
  DP parameters ε = ε_{leakage} + ε_{counts}, δ = δ_{leakage} + δ_{counts}, sensitivity Δ.
  Free Noise Parameters T, T′ chosen by grid search in Section 6.2.
  Determined Noise Parameters λ₁ = 2Δ/ε_{counts}, t₁ ≥ Δ + λ₁ log(2/δ_{counts}),
λ₂ = 1/ε_{leakage}, t₂ ≥ λ₂log(1/δ_{leakage}), threshold τ = Δ + 2t₁ + 1.
```

Inputs:

```
  Clientᵢ: an index-value pair (uᵢ, vᵢ) ∈ [symbol]   × [symbol] .
  P1: ElGamal secret key SK₁ ∈ [symbol]  _{q} is the secret key for PK₁, additive HE secret key
SK_{AHE} corresponding to PK_{AHE}, a secret PRF key K ← [symbol]  _{q}
  P2: ElGamal secret keys SK₂, SK′ ∈ [symbol]  _{q}, where SK₂ is the secret key for PK₂, and SK′
is the secret for PK′, and decryption key SK″ corresponging to PK″ for semantically secure
encryption.
```

Protocol:

```
  (1) Each Clientᵢ computes hᵢ ← H(uᵢ) and wᵢ ← Enc_{HE}(PK_{AHE}, vᵢ) and encrypts.
    (aᵢ, bᵢ, cᵢ) ← (Enc_{ElGamal}(PK′, hᵢ), Enc_{ElGamal}(PK, uᵢ), Enc(PK″, wᵢ)).
  (2) P1 receives the ciphertexts from all clients [symbol]  ⁽¹⁾ = {(aᵢ, bᵢ, cᵢ)}_{i∈[n]}.
      (a) [symbol]  ⁽¹⁾ ← [symbol]  ⁽¹⁾ ∪ SampleDummies(T, T′, ε_{leakage}, δ_{leakage}, [symbol]  ⁽¹⁾).
      (b) Choose random K ←_{R} [symbol]  _{q} and set [symbol]  ⁽²⁾ ← ∅.
      (c) For every tuple (aᵢ, bᵢ, cᵢ) ∈ [symbol]  ⁽¹⁾:
        (i) Unpack (ct₁, ct₂) ← aᵢ.
        (ii) a′ᵢ ← (ct₁^{K}, ct₂^{K}).
        (iii) [symbol]  ⁽²⁾ ← [symbol]  ⁽²⁾ ∪ {(a′ᵢ, bᵢ, cᵢ)}.
      (d) Shuffle [symbol]  ⁽²⁾ and send the result to P2.
  (3) P2 received [symbol]  ⁽²⁾ = {(a′ᵢ, b′ᵢ, c′ᵢ)}_{i∈[n′]} from P1 and computes:
      (a) Decrypts all three components of each ciphertext as follows
            h′ᵢ ← Dec_{ElGamal}(SK′, a′ᵢ), w′ᵢ ← Dec(SK″, c′ᵢ)
and sets [symbol]  ⁽³⁾ = {(h′ᵢ, b′ᵢ, w′ᵢ)}_{i∈[n′]}.
      (b) Partitions the tuples in S⁽³⁾ based on the first component by defining [symbol]  ᵢ =
{j|h′ⱼ = h′ᵢ}.
      (c) For each unique value h′ᵢ in the first components of the tuples in [symbol]  ⁽³⁾,
homomorphically adds up all third components and chooses one of the second components at
random. This results in a set (ordered by h′ᵢ): [symbol]  ⁽⁴⁾ = ((h″ᵢ, d′ᵢ, w″ᵢ)_{i∈[n″]} containing n″ ≤ n′
tuples of the form:
        $( {H ( {u}_{i}^{″} )}^{K} , {Enc}_{ElGamal} ( PK , {u}_{i}^{″} ) , {Enc}_{HE} ( {PK}_{AHE} , {v}_{j}^{″} ) ) .$
      (d) [symbol]  ⁽⁴⁾ ← [symbol]  ⁽⁴⁾ ∪ SampleBuckets(PK_{AHE}, λ₂, t₂).
      (e) Shuffle [symbol]  ⁽⁴⁾.
  (4) Let (d′ᵢ)_{i∈[n″]} and (w″ᵢ)_{i∈[n″]} be the ordered sets (in the same order) of the
second and third components of [symbol]  ⁽⁴⁾. P1 and P2 invoke Π_{threshold} where P1 has input SK_{AHE}
and P2 has inputs (w″ᵢ)_{i∈[n″]}, setting τ, λ₁, and t₁ as above. Let (valᵢ)_{i∈[n″]} be the output that
P1 receives. Moreover, P2 sends (Randomize_{ElGamal}(d′ᵢ))_{i∈[n″]} them to P1.
  (5) Let V = {(d′ᵢ, valᵢ)|i ∈ [n″], valᵢ ≠ 0} be the index - value pairs (with encrypted
index) obtained by P1 in the previous step, excluding pairs with value 0. P1 sends to P2 the
following set, randomly shuffled.
        D = {Randomize_{ElGamal}(d)|(d, v) ∈ V}.
  (6) P2 computes {PartialDec_{ElGamal}(SK₂, d)|d ∈ D} and sends it to P1 in the same
order.
  (7) P1 reverts the shuffle on D from Step 5 and outputs
{Dec_{ElGamal}(SK₁, d), v)|(d, v) ∈ V}.
```

Example Algorithm SampleDummies

```
  Parameters: Thresholds T and T′, privacy parameters ε_{leakage} and δ_{leakage}, dummy
index domain [symbol]   , a set of messages [symbol]    = {(aᵢ, bᵢ, cᵢ)}_{iϵ[n]}.
  Algorithm:
  (1) Find λ₃, t₃, r, p, T″ and {ηⱼ}_{T≤j≤T″} with T, T′, ε = ε_{leakage}/2, δ =
δ_{leakage}/2(1 + exp(ε)) and \hat{δ} = δ_{leakage}/2.
  (2) [symbol]    ← [symbol]    ∪ Sample FrequencyDummies(λ₃, t₃, T, [symbol]   ).
  (3) [symbol]    ← [symbol]    ∪ SampleDuplicateDummies( [symbol]  , r, p).
  (4) [symbol]    ← [symbol]    ∪ SampleBlanketDummies({ηⱼ}ⱼ, T, T″).
  (5) Return [symbol]   .
```

Example Algorithm SampleFrequencyDummies

```
  Parameters: Threshold T, noise parameters λ₃ and t₃, dummy index domain [symbol]
  Algorithm:
  (1) [symbol]    ← Ø
  (2) For every i = 1, ... , T:
    (a) Randomly draw Nᵢ from TSDLap(λ₃, t₃).
    (b) For j = 1, ... , Nᵢ:
      (i) Randomly select x′ ←_{R} [symbol]   .
      (ii) Perform Step 1 of Πₕᵢₛₜ i times, simulating a client with input (x′, 0). Add
the resulting ciphertexts to [symbol]   .
  (3) Return [symbol]   .
```

Example Algorithm SampleDuplicateDummies

```
  Parameters:
  AHE Public key PK, noise parameters r and p, dummy index domain [symbol]   , a set of
messages [symbol]    = {(aᵢ, bᵢ, cᵢ)}_{iϵ[n]}, where all bᵢ are re-randomizeable ElGamal ciphertexts.
  Algorithm:
  (1) [symbol]    ← Ø
  (2) For every i ϵ [n]:
    (a) Randomly draw Nᵢ from NBin(r, p).
    (b) For j = 1, ... , Nᵢ add (aᵢ, b′ⱼ, Enc_{AHE}(PK, 0)) to [symbol]   , where b′ⱼ =
Randomize_{ElGamal}(bⱼ).
  (3) Return [symbol]   .
```

Example Algorithm SampleBlanketDummies

```
  Public key PK, noise intensities ηⱼ, dummy index domain [symbol]   , thresholds T, T″.
  (1) [symbol]    ← Ø
  (2) For every T ≤ j ≤ T″:
    (a) Repeat Poi(ηⱼ) times.
      (i) Randomly select x′ ←_{R} [symbol]   .
      (ii) Perform step 1 of Πₕᵢₛₜ j times, simulating a client with input (x′, 0). Add
the resulting ciphertexts to [symbol]   .
  (3) Return [symbol]   .
```

Example Functionality [symbol] =( [symbol] ). Πₕᵢₛₜ securely implements [symbol] with leakage [symbol] .

```
  Public parameters:
    - Boundary T.
    - Noise distribution parameters λ₁, λ₂, λ₃, t₁, t₂, t₃, r, p and ηᵢ for i ≥ T
  Inputs:
  Clients: Index-value pairs [symbol]    = (indᵢ, valᵢ)_{iϵ[n]}.
  Functionality:
  (1) Let [symbol]   ⁰ be an anonymized histogram of the first components of the inputs. That
is, [symbol]   ᵢ⁰ denotes the number of distinct buckets in the input that appear exactly i times.
  (2) Initialize [symbol]   ¹, [symbol]   ³, [symbol]   ⁴ to Ø.
  (3) Initialize [symbol]   ¹ ← [symbol]   ⁰. For every i = 1, ... , T:
    (a) Draw Nᵢ ←_{R} TSDLap(λ₃, t₃).
    (b) [symbol]   ¹ ← [symbol]   ¹ ∪ {(i, Nᵢ)}
    (c) [symbol]   ᵢ¹ ← [symbol]   ᵢ¹ + Nᵢ
  (4) Initialize [symbol]   ² to an empty histogram.
    For every i s.t. [symbol]   ᵢ¹ ≠ 0, repeat [symbol]   ᵢ¹ times:
    (a) Draw a ←_{R} NBin(i · r, p).
    (b) [symbol]   ᵢ₊ₐ² ← [symbol]   ᵢ₊ₐ² + 1
  (5) Initialize [symbol]   ³ ← [symbol]   ². For every T ≤ i ≤ T″:
    (a) Draw N′ᵢ ←_{R} Poi(ηᵢ)
    (b) [symbol]   ³ ← [symbol]   ³ ∪ {(i, N′ᵢ)}
    (c) [symbol]   ᵢ³ ← [symbol]   ᵢ³ + N′ᵢ
  (6) Let [symbol]   ′ = ((ind_{i′}, val_{j′}))_{iϵ[n′]} be the input [symbol]    grouped by first component, summing
up the second components, shuffled.
    For each j ϵ [Δ]:
    (a) Draw Mⱼ from TSDLap(λ₂, t₂)
    (b) [symbol]   ⁴ ← [symbol]   ⁴ ∪ {(j, Mⱼ)}
    (c) [symbol]   ′ ← [symbol]   ′||(⊥, j)^{Mj}
  (7) Let ξ⁽¹⁾, ξ⁽²⁾ ←_{R} TDLap(λ₁, t₁)^{[} [symbol] ^{′]}, and let ξ = ξ⁽¹⁾ + ξ⁽²⁾.
  (8) Let [symbol]   ″ = ((indⱼ, valⱼ + ξⱼ)|j ϵ [| [symbol]  ′|, [symbol]   ′ⱼ = (indⱼ, valⱼ)).
  (9) Define [symbol]   ₕᵢₛₜ P1 ← {(ind, val)|(ind, val) ϵ [symbol]   ″, val ≥ τ}.
  (10) Define [symbol] ₕᵢₛₜ P2 ← Ø.
  (11) Define [symbol]   ^{⊥} ← {val|(ind, val) ϵ [symbol]   ″, val < τ}.
  (12) [symbol]   ₕᵢₛₜP1 ← ( [symbol]  ¹, [symbol]   ³, ξ⁽¹⁾, [symbol]   ^{⊥}), [symbol]   ₕᵢₛₜP2 ← ( [symbol]  ³, [symbol]   ⁴, ξ⁽²⁾).
  (13) The functionality with leakage [symbol]   ₕᵢₛₜ is defined to be the joint distribution
( [symbol]  ₕᵢₛₜP1, [symbol] ₕᵢₛₜP2) with [symbol] ₕᵢₛₜ^{Pi} = ( [symbol] ₕᵢₛₜ^{Pi}, [symbol]   ₕᵢₛₜ^{Pi}).
```

Example Algorithm SampleBuckets

```
  Parameters: AHE Public key PK, noise parameters λ₂, t.
  Algorithm:
  (1) [symbol]    ← Ø
  (2) For j ϵ [Δ]:
    (a) Sample Mⱼ ← TSDLap( λ₂, t).
    (b) For k ϵ [Mⱼ], generate dummy record (⊥, ⊥, Enc(PK, j)), and concatenate
these dummies with [symbol]   .
  (3) Return [symbol]   .
```

Example Hybrid Protocol: Per-Multiplicity and Duplication.

This section starts by analyzing the hybrid method without Poisson supplement noise described in the overview, i.e., the case T=T′. An example analysis consists of two cases, based on whether the count is below T or above T′. In the former, the privacy guarantee follows that of the truncated Laplace mechanism, which gives:

[Privacy for Low Counts] [symbol] ³ and [symbol] ^{3′} are (ε, δ)-indistinguishable if m₁≤T, λ≥2/ε and t≥1+λ log(2/δ).

For the latter case, an analysis can show that 1+ [symbol] ≡_{ε,δ} [symbol] where [symbol] =NBin(r,p). Using the tail bound of negative binomial noise, example implementations can select concrete parameters as follows.

[Privacy for High Counts] Let ε, δ∈(0,1). [symbol] ³ and [symbol] ^{3′} are (ε, δ)-indistinguishable if m₁>T′ where

$${T}^{′} \geq 3 ( 1 + log ( 2 / δ ) ) \cdot ( \frac{4}{ε} ( 1 + log ( 1 / ε ) ) + \frac{100}{{ε}^{2}} ) , r = \frac{3 ( 1 + log ( 2 / δ ) )}{{T}^{′}}$$

and p=e^{-0.2ε}.

These lemmas are sufficient to prove privacy for the hybrid method without Poisson supplement noise (i.e., if example implementations take T=T′ and ηⱼ=0 for all j). In this case, we get the following theorem.

Theorem: Let

$$ε , δ ∈ ( 0 , 1 ) . If T = {T}^{′} \geq 3 ( 1 + log ( 2 / δ ) ) \cdot ( \frac{4}{ε} ( 1 + log ( 1 / ε ) ) + \frac{100}{{ε}^{2}} ) ,$$

$$λ \geq 2 / ε , t \geq 1 + λ log ( 2 / δ ) , r = \frac{3 ( 1 + log ( 2 / δ ) )}{{T}^{′}}$$

and p=e^{-0.2ε}, then the algorithm given as SampleDummies is (ε, δ)-add/remove DP. It is then immediate that it is (2ε, (1+exp(ε))δ)-DP.

Furthermore, for log(1/δ)/ε=o(n^{1/3}), if example implementations take T(=T′)=Θ(n^{1/3}), then the expected number of dummy messages generated and sent in step (2) is Θ(n^{2/3} log(1/δ)/ε)

To cover the case T<m₁<T′, example implementations must make use of the Let Nᵢ˜NBin(ri,p) and let τ_{i,j}= [symbol] (Nᵢ=j−i) (this is the probability that a message with multiplicity i is duplicated to have multiplicity j). To consider the change made by increasing i by one, some example implementations take the smallest q that allows the following breakdown, with α_{i,j}, β_{i,j} and γ_{i,j} distributions:

τ_{i,j}=qᵢα_{i,j}+(1−qᵢ)γ_{i,j}

and

τ_{i+1,j}=qᵢβ_{i,j}+(1−qᵢ)γ_{i,j}.

Further, define μᵢ to be the smallest μ such that if A, B, C˜Poi(μ) are independent then

$$ℙ ( \frac{{q}_{i} A + ( 1 - {q}_{i} ) C + 1}{{q}_{i} B + ( 1 - {q}_{i} ) C} > exp ε ) \leq δ .$$

The main privacy guarantee of this approach is stated below.

If for all j

ηⱼ≥μ_{m′}_{₁}(α_{m′}_{₁}_{,j}+β_{m′}_{₁}_{,j}γ_{m′}_{₁}_{,j}),

then [symbol] ³ and [symbol] ^{3′} are (ε, δ)-indistinguishable

The final privacy guarantee is stated in the following theorem. It is shown in example experiments that this protocol in practice achieves an improvement over the T=T′ case in communication.

Theorem: Let ε, δ∈(0,1). For given T, T′, let

$$λ \geq 2 / ε , t \geq 1 + λ log ( 2 / δ ) , r = \frac{3 ( 1 + log ( 2 / δ ) )}{{T}^{′}} ,$$

p=e^{-0.2ε}. Further, let

$${η}_{j} = {max}_{T < i < {T}^{′}} {μ}_{i} ( {α}_{i , j} + {β}_{i , j} + {γ}_{i , j} ) ,$$

for all j, and choose T″ so that Σ_{j>T″} ηⱼ≤\hat{δ}.

Then so long as

$${T}^{′} \geq 3 ( 1 + log ( 2 / δ ) ) \cdot ( \frac{4}{ε} ( 1 + log ( 1 / ε ) ) + \frac{100}{{ε}^{2}} ) ,$$

then [symbol] ³ is (ε, δ)-add/remove DP. It is then immediate that it is (2ε, (1+exp(ε))δ+\hat{δ})-DP.

### Example Devices and Systems

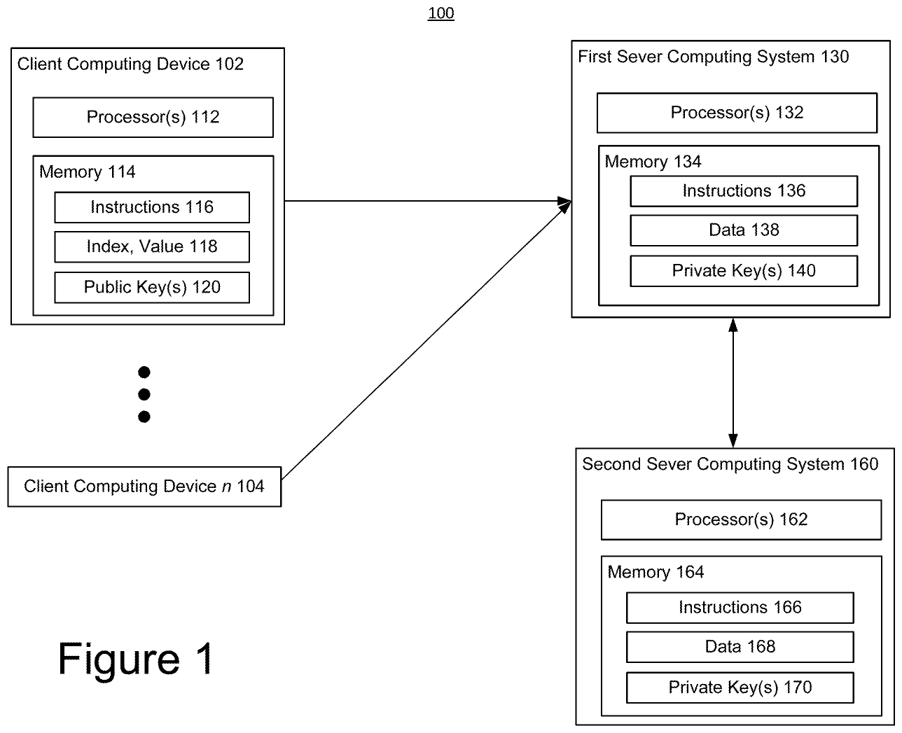

FIG. 1 depicts an example computing system 100 according to example embodiments of the present disclosure. The system 100 includes a number (n) of client computing devices (shown as client computing device 102 and nth client computing device 104). The system 100 also includes a first server computing system 130 and a second server computing system 160.

The system 100 can include any number of client computing devices (e.g., tens, hundreds, thousands, millions, billions, etc.). The client computing device can be any type of device include a smartphone, tablet, laptop, personal computer, gaming console, embedded system or device, smart device, Internet of Things device, wearable device, telemetry device, etc. The client computing device 102 is shown as a representative.

The client computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store instructions 116 which are executed by the processor 112 to cause the client computing device 102 to perform operations (e.g., to perform any of the methods, operations, and/or protocols described herein).

The memory 114 of the client computing device 102 can also include a respective index, value pair 118 associated with the client computing device. The index can, for example, identify or otherwise be associated with the client computing device 102. For example, the index can be a user account, a device identifier, and/or other index. The value can, in some implementations, be a value collected at the client computing device 102. For example, the value can be a sensor reading, user data, and/or other values. In some implementations, a client computing device can include multiple index, value pairs and can transmit some or all of the multiple index, value pairs to the first server computing system 130.

The memory 114 of the client computing device 102 can also include a number of public keys 120. The public keys 120 can have corresponding private keys (e.g., private keys 140 and 170) that are stored by the first server computing system 130 and the second server computing system 160, respectively.

The first server computing system 130 can include one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store instructions 138 which are executed by the processor 132 to cause the first server computing system 130 to perform operations (e.g., any of the methods, operations, and/or protocols described herein). The memory 134 can also include data 138 and one or more private keys 140.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

The second server computing system 160 can include one or more processors 162 and a memory 164. The one or more processors 162 can be any suitable processing device (e.g., a processor core, a microprocessor, an ASIC, an FPGA, a controller, a microcontroller, etc.) and can be one processor or a plurality of processors that are operatively connected. The memory 164 can include one or more non-transitory computer-readable storage media, such as RAM, ROM, EEPROM, EPROM, flash memory devices, magnetic disks, etc., and combinations thereof. The memory 164 can store instructions 168 which are executed by the processor 162 to cause the second server computing system 160 to perform operations (e.g., any of the methods, operations, and/or protocols described herein). The memory 164 can also include data 168 and one or more private keys 170.

In some implementations, the server computing system 160 includes or is otherwise implemented by one or more server computing devices. In instances in which the server computing system 160 includes plural server computing devices, such server computing devices can operate according to sequential computing architectures, parallel computing architectures, or some combination thereof.

The client computing device(s) and the server systems 130 and 160 can communicate with each other over a network. The network can include any number of wired or wireless links.

### Example Protocols Visualizations

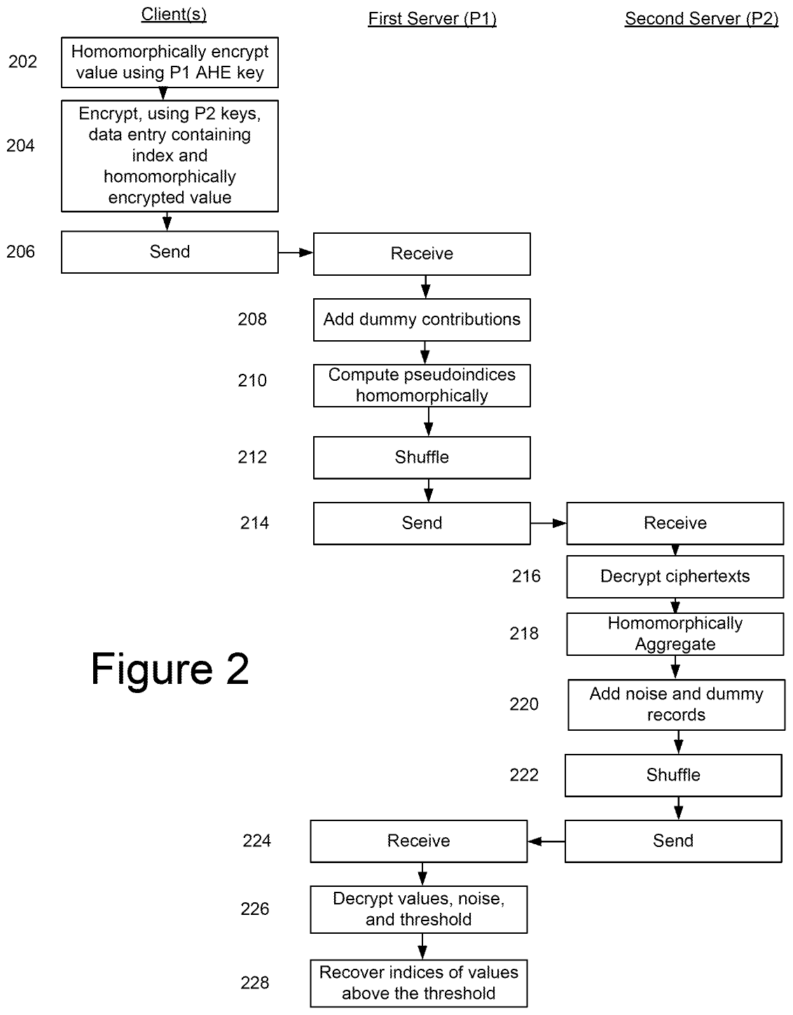

FIG. 2 depicts an example protocol for secure and private aggregation according to example embodiments of the present disclosure. FIG. 2 shows in respective swim lanes operations respectively performed by client device(s), a first server system, and a second server system.

Referring to FIG. 2, at 202 each client device can homomorphically encrypt a respective value stored at the client. For example, each client device can use a public homomorphic encryption key to generate a first encrypted value from the value. For example, a private homomorphic encryption key that corresponds to the public homomorphic encryption key can be held by the first server computing system. In some examples, the homomorphic encryption keys can be additive homomorphic encryption keys.

At 204, each client device can encrypt a respective index stored at the client. For example, each client device can encrypt the respective index using one or more second public keys. For example, one or more second private keys that correspond to the one or more second public keys are held by the second server computing system.

In some implementations, at 204 each client device can create one or both of the following variants of the index. In a first variant of the index, the client device can hash the index to generate a hashed index. Next, the client device can encrypt the hashed index using a first semantic public key to generate a first ciphertext component. A first semantic private key that corresponds to the first semantic public key can be held by the second server computing system.

In a second variant of the index, the client device can encrypt the index using a combined public key to generate a second ciphertext component. For example, the combined public key can be derived from a combination of two or more public keys that have private counterparts respectively separately held by the first server computing system and the second server computing system.

In addition, in some implementations, at 204, each client device can further encrypt the first encrypted value generated at 202 using one or more second public keys. For example, the client device can further encrypt the first encrypted value using a second semantic public key to generate a third ciphertext component. A second semantic private key that corresponds to the second semantic public key can be held by the second server computing system.

At 206, each client device can send the encrypted information to the first server computing system. For example, each client device can transmit a ciphertext to first server computing system, where the ciphertext contains some or all of the encrypted components described above. As one example, the ciphertext can include the first ciphertext component, the second ciphertext component, and the third ciphertext component. The set of all ciphertexts received by the first server computing system from all client computing devices can be referred to as a first ciphertext set.

At 208, the first server computing system can add one or more dummy contributions (e.g., to the first ciphertext set). For example, generating the one or more dummy contributions can include sampling one or more frequency dummy contributions; sampling one or more duplicate dummy contributions; and/or sampling one or more blanket dummy contributions.

In some implementations, sampling frequency dummy contributions can include, for each of a threshold number of iterations: randomly drawing a sample index; and, for each of 1 through the sample index: randomly selecting a dummy bucket and generating a number of dummy ciphertexts for the dummy bucket with value zero.

In some implementations, sampling duplicate dummy contributions can include, for each index: randomly drawing a sample index; and, for each of 1 through the sample index, adding a duplicate ciphertext with value zero.

In some implementations, sampling blanket dummy contributions can include, for every index greater or equal to a threshold number: and for each of a number of times selected from a Poisson distribution: randomly selecting a dummy bucket and generating a number of dummy ciphertexts for the dummy bucket with value zero.

At 210, the first server computing system can compute (e.g., homomorphically) a respective pseudoindex for each ciphertext in the first set of ciphertexts. The first server computing system can insert the respective pseudoindex for each ciphertext into the ciphertext (e.g., replacing the previous first ciphertext component). After modifying each ciphertext to include the respective pseudoindex computed for such ciphertext, the collection of modified ciphertexts can be referred to as a second set of ciphertexts.

As one example, at 210, the first server computing system can compute the pseudoindex from the first ciphertext component using a hash function and key held by the first server computing system. For example, the hash function can be a pseudorandom function. For example, the hash function can be an oblivious pseudorandom function. As one example, computing the pseudoindex can include unpacking the first ciphertext component into two components of messages in ElGamal encryption, hashing each message component, and repacking as the pseudoindex.

At 212, the first server computing system can shuffle the second set of ciphertexts. At 214, the first server computing system can transmit the second set of ciphertexts to the second server computing system.

At 216, the second server computing system can decrypt each of the ciphertexts included in the second set of ciphertexts.

Specifically, in some implementations, at 216, the second server computing system can partially decrypt each pseudoindex using the first semantic private key that corresponds to the first semantic public key.

Further, at 216, the second server computing system can use the respective private key separately held by the second server computing system to partially decrypt the respective index (e.g., the second ciphertext component) and generate a respective partially decrypted index.

Further, at 216, the second server computing system can decrypt the respective value in each modified ciphertext using the second semantic private key associated with the second semantic public key to obtain a partially decrypted value for each ciphertext.

After the decryption performed at 216, the results can be referred to as a third set of ciphertexts.

At 218, the second server computing system can homomorphically aggregate the values (e.g., the partially decrypted values included in the third set of ciphertexts). For example, the second server computing system can partition (e.g., sort) the third set of ciphertexts based on the pseudoindices (e.g., based on the partially decrypted pseudoindices included in the third set of ciphertexts, to form a number of partitions (groups) of ciphertexts having a shared first component). The second server computing system can select one of the second components at random for each partition. The second server computing system can homomorphically add up the third components to generate a set of aggregated values. The results of this process can be referred to as a fourth set of ciphertexts.

At 220, the second server computing system can add noise to the fourth set of ciphertexts and/or add one or more dummy records to the fourth set of ciphertexts. For example, the noise can be added homomorphically.

At 222, the second server computing system can shuffle the fourth set of ciphertexts. At 224, the second server computing system can send the fourth set of ciphertexts to the first server computing system.

At 226, the first server computing system can decrypt the values included in the fourth set of ciphertexts. For example, the first server computing system can use a private homomorphic encryption key that corresponds to the public homomorphic encryption key to decrypt the set of aggregated values to generate a set of decrypted, aggregated values.

In some implementations, the first server computing system can add further noise to the set of decrypted, aggregated values. In some implementations, the first server computing system can threshold the set of decrypted, aggregated values. For example, thresholding the set of decrypted, aggregated values can include removing one or more of the set of decrypted, aggregated values that is less than a threshold value.

At 228, the first server computing device can recover the indices of the values (e.g., any values above the threshold). For example, the first server computing system can return the set of decrypted, aggregated values to the second server computing system. The second server computing system can de-shuffle the set of decrypted, aggregated values. The second server computing system can identify any partially decrypted indices that have non-zero values. The second server computing system can transmit a list of partially decrypted indices that have non-zero values to the first server computing system. The first server computing system can then further (fully) decrypt the indices using the respective private key that is separately held by the first server computing system. The first server system can output the final set of indices and decrypted, aggregated values and/or transmit to the second server computing system the final set of indices and decrypted, aggregated values.

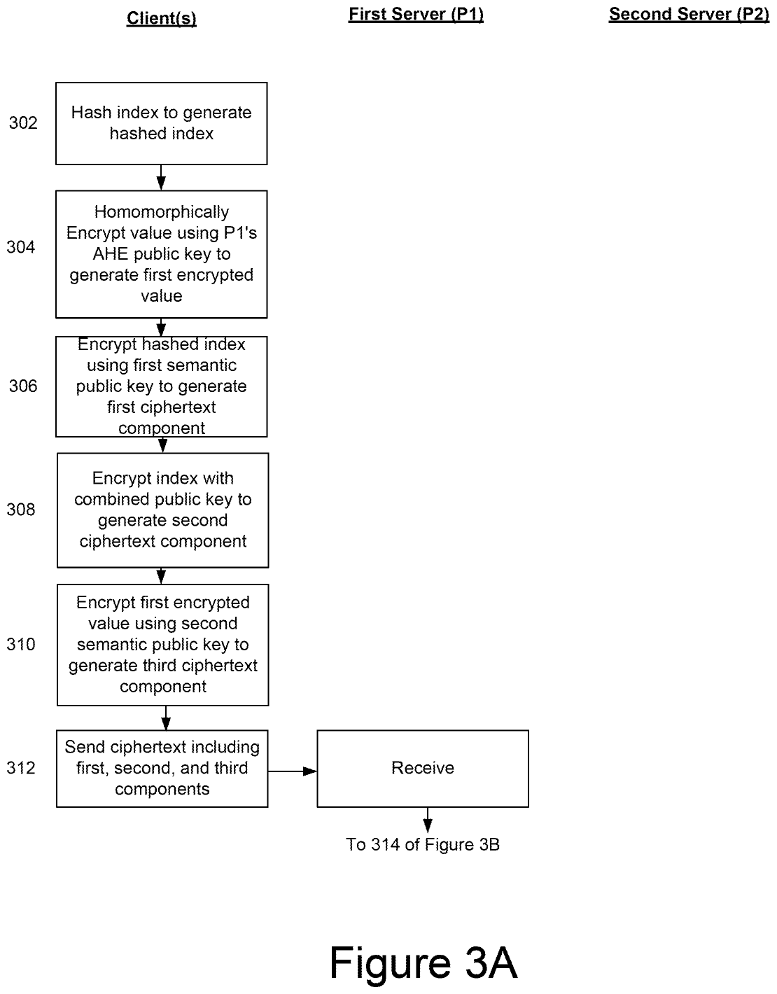

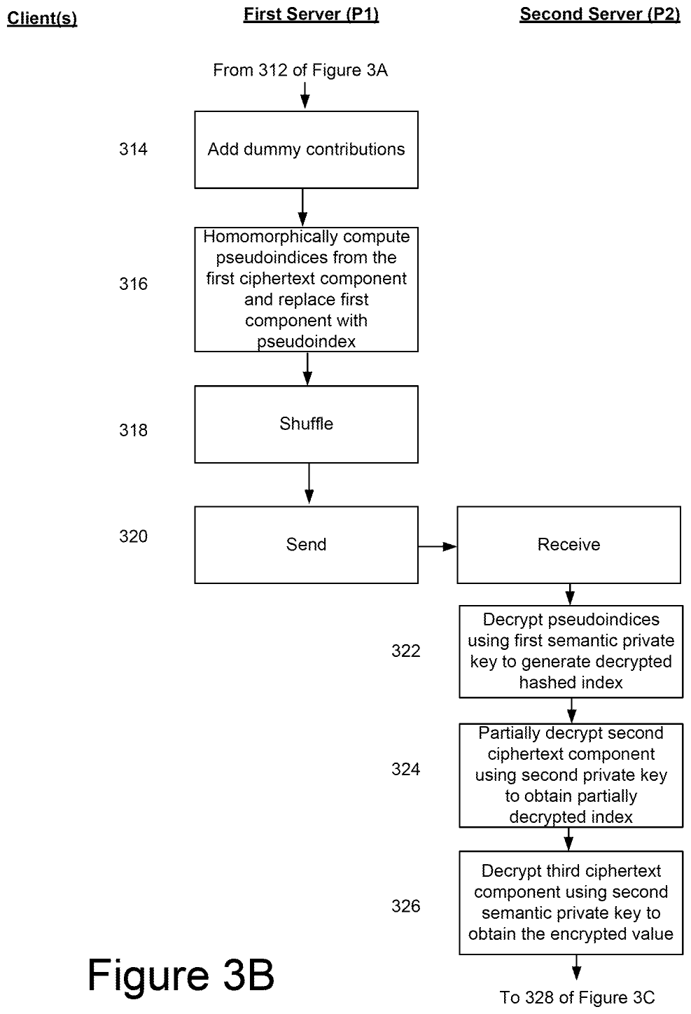

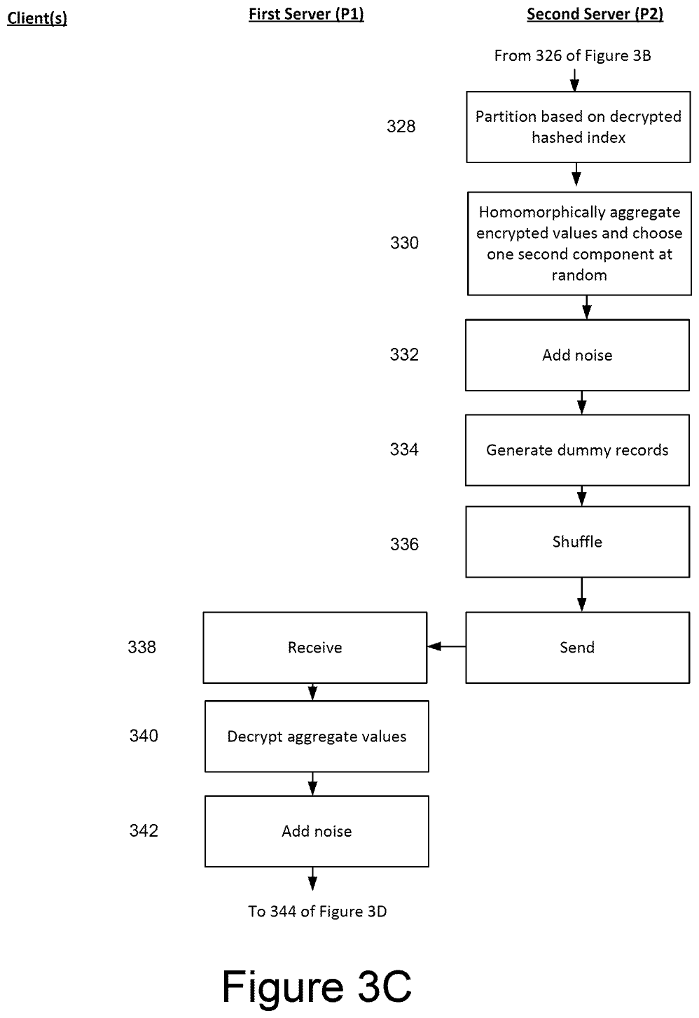

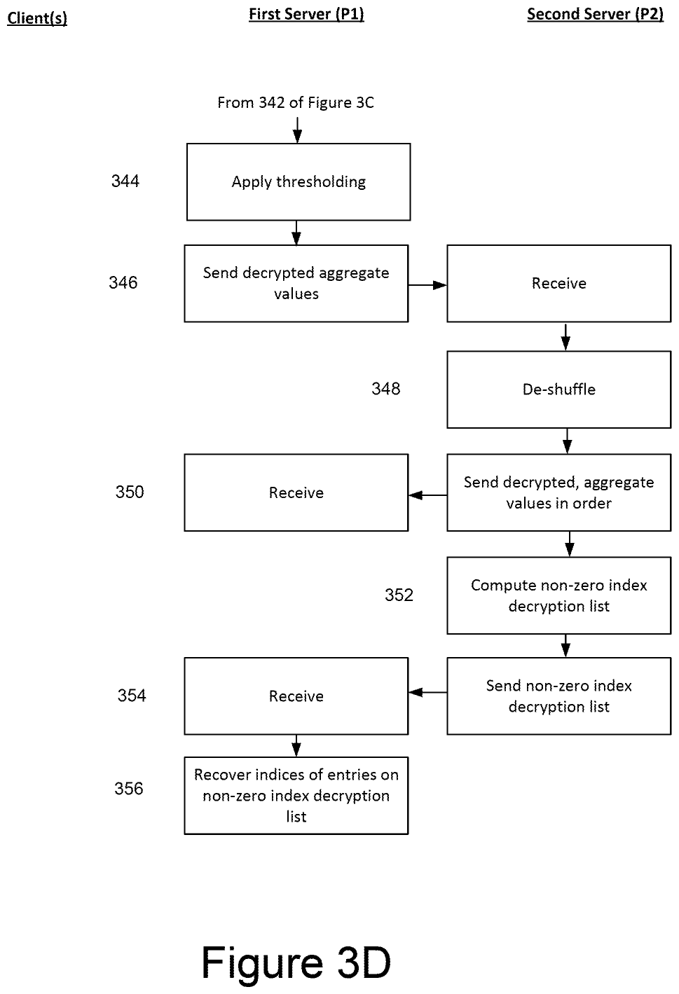

FIGS. 3A-D depict an example protocol for secure and private aggregation according to example embodiments of the present disclosure. FIGS. 3A-D show in respective swim lanes operations respectively performed by client device(s), a first server system, and a second server system.

At 302, each client computing device can hash a respective index to generate a hashed index.

At 304, each client computing device can homomorphically encrypt a respective value using a public additive homomorphic encryption key associated with the first server computing system. For example, a private homomorphic encryption key that corresponds to the public homomorphic encryption key can be held by the first server computing system.

At 306, each client computing device can encrypt the hashed index using a first semantic public key to generate a first ciphertext component. A first semantic private key that corresponds to the first semantic public key can be held by the second server computing system.

At 308, each client computing device can encrypt the respective index with a combined public key to generate a second ciphertext component. For example, the combined public key can be derived from a combination of two or more public keys that have private counterparts respectively separately held by the first server computing system and the second server computing system.

At 310, each client computing device can encrypt the first encrypted value using a second semantic public key to generate a third ciphertext component. A second semantic private key that corresponds to the second semantic public key can be held by the second server computing system.

At 312, each client computing device can send a ciphertext including the first, second, and third components to the first server computing system.

Referring now to FIG. 3B, at 314, the first server computing system can add one or more dummy contributions. For example, generating the one or more dummy contributions can include sampling one or more frequency dummy contributions; sampling one or more duplicate dummy contributions; and/or sampling one or more blanket dummy contributions.

In some implementations, sampling frequency dummy contributions can include, for each of a threshold number of iterations: randomly drawing a sample index; and, for each of 1 through the sample index: randomly selecting a dummy bucket and generating a number of dummy ciphertexts for the dummy bucket with value zero.

In some implementations, sampling duplicate dummy contributions can include, for each index: randomly drawing a sample index; and, for each of 1 through the sample index, adding a duplicate ciphertext with value zero.

In some implementations, sampling blanket dummy contributions can include, for every index greater or equal to a threshold number: and for each of a number of times selected from a Poisson distribution: randomly selecting a dummy bucket and generating a number of dummy ciphertexts for the dummy bucket with value zero.

At 316, the first server computing system can respectively homomorphically compute pseudoindices from the first ciphertext components and respectively replace the first ciphertext components with the pseudoindices. As one example, at 316, the first server computing system can compute the pseudoindex from the first ciphertext component using a hash function and key held by the first server computing system. For example, the hash function can be a pseudorandom function. For example, the hash function can be an oblivious pseudorandom function. As one example, computing the pseudoindex can include unpacking the first ciphertext component into two components of messages in ElGamal encryption, hashing each message component, and repacking as the pseudoindex.

At 318, the first server computing system can shuffle the ciphertexts.

At 320, the first server computing system can send the ciphertexts to the second server computing system.

At 322, the second server computing system can decrypt the pseudoindices using the first semantic private key to generate a decrypted hashed index.

At 324, the second server computing system can partially decrypt the second ciphertext component using the second private key to obtain a partially decrypted index. The second private key can be a private analog to the public key separately held by the second server computing device and used to generate the combined public key.

At 326, the second server computing system can decrypt the third ciphertext component using the second semantic private key to obtain the encrypted value.

Referring now to FIG. 3C, at 328, the second server computing system can partition the ciphertexts based on the decrypted hashed indices.

At 330, the second server computing system can homomorphically aggregate the encrypted values for each partition. For each respective partition, the second server computing system can choose one second component at random from the group of second components included in that partition to serve as a representative for that partition.

At 332, the second server computing system can add noise to the aggregated values. For example, the noise can be added homomorphically.

At 334, the second server computing system can generate one or more dummy records.

At 336, the second server computing system can shuffle the aggregated values (e.g., according to a permutation).

At 338, the second server computing system send the aggregated values to the first server computing system.

At 340, the first server computing system can decrypt the aggregated values. For example, the first server computing system can use the private homomorphic encryption key that corresponds to the public homomorphic encryption key to decrypt the set of aggregated values to generate a set of decrypted, aggregated values.

At 342, the first server computing system can add noise to the decrypted, aggregate values.

Referring now to FIG. 3D, at 344, the first server computing system can apply thresholding to the decrypted, aggregate values. For example, thresholding the set of decrypted, aggregated values can include removing one or more of the set of decrypted, aggregated values that is less than a threshold value.

At 346, the first server computing system can send the decrypted, aggregate values to the second server computing system.

At 348, the second server computing system can de-shuffle the decrypted, aggregate values. For example, the second server computing system can apply the inverse of the permutation applied at 336.

At 350, the second server computing system can send the decrypted, aggregate values in the de-shuffled order to the first server computing system. In some implementations, operation 350 is performed in unison with operation 354, described below.

At 352, the second server computing system can compute a non-zero index decryption list. The non-zero index decryption list can identify/provide any partially decrypted indices that have non-zero values.

At 354, the second server computing system can send the non-zero index decryption list to the first server computing system.

At 356, the first server computing system can recover the indices of each of the entries on the non-zero index decryption list. For example, the first server computing system can further (fully) decrypt the partially decrypted indices using the respective private key that is separately held by the first server computing system (e.g., and which corresponds to the public key used to generate the combined public key). The first server system can output the final set of indices and decrypted, aggregated values and/or transmit to the second server computing system the final set of indices and decrypted, aggregated values.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

In particular, although FIGS. 2 and 3A-D respectively depict steps performed in a particular order for purposes of illustration and discussion, the methods of the present disclosure are not limited to the particularly illustrated order or arrangement. The various steps of the methods 2 and 3A-D can be omitted, rearranged, combined, and/or adapted in various ways without deviating from the scope of the present disclosure.

What is claimed is:

1. A client computing device configured to perform client operations to enable private and secure multi-party computation, the client operations comprising:
obtaining a data entry comprising an index and a value;
homomorphically encrypting the value using a public homomorphic encryption key to generate a first encrypted value, wherein a private homomorphic encryption key that corresponds to the public homomorphic encryption key is held by a first server computing system;
encrypting the index and the first encrypted value with one or more second public keys to generate a ciphertext, wherein one or more second private keys that correspond to the one or more second public keys are held by a second, different server computing system; and
transmitting the ciphertext to the first server computing system for collaborative aggregation by the first server computing system and the second computing system.

2. The client computing device of claim 1, wherein the client operations further comprise, prior to said encrypting:
hashing the index to generate a hashed index;
wherein said encrypting the index with the one or more second public keys comprises:
encrypting the hashed index using a first semantic public key to generate a first ciphertext component; and
encrypting the index using a combined public key to generate a second ciphertext component, wherein the combined public key comprises a combination of two or more public keys that have private counterparts respectively separately held by the first server computing system and the second server computing system.

3. A first server computing system comprising one or more server computing devices, the first server computing system configured to perform first server system operations to enable private and secure multi-party computation, the first server system operations comprising:
receiving a respective ciphertext from each of a plurality of client devices, wherein each ciphertext comprises:
a value that has been encrypted using both:
a public homomorphic encryption key associated with the first server computing system; and
an additional public key associated with a second, different server computing system;
computing a respective pseudoindex for each ciphertext and inserting the respective pseudoindex into the ciphertext;
transmitting the modified ciphertexts to the second server computing system for the second server computing system to compute homomorphic aggregation of the encrypted values partitioned on the basis of pseudoindex;
receiving a set of aggregated values from the second server computing system; and
using a private homomorphic encryption key that corresponds to the public homomorphic encryption key to decrypt the set of aggregated values to generate a set of decrypted, aggregated values.

4. The first server computing system of claim 3, wherein:
the respective ciphertext received from each of the plurality of client devices further comprises a respective first ciphertext component, the first ciphertext component comprising a hashed version of the index that has been encrypted using a semantic public key associated with the second server computing system; and
computing the respective pseudoindex for each ciphertext comprises computing the pseudoindex from the first ciphertext component using a hash function and key held by the first server computing system.

5. The first server computing system of claim 3, wherein:
the respective ciphertext received from each of the plurality of client devices further comprises a respective index that has been encrypted using a combined public key generated from two or more private keys respectively separately held by the first server computing system and the second server computing system;
each of the set of aggregated values received from the second server computing system has a respective partially decrypted index associated therewith, each partially decrypted index having been generated by the second server computing system using the respective private key separately held by the second server computing system; and
for at least one of the set of aggregated values, the first server operations further comprise:
further decrypting the corresponding partially decrypted index using the respective private key separately held by the first server computing system to recover the original respective index.

6. The first server computing system of claim 3, wherein the first sever system operations further comprise, prior to transmitting the modified ciphertexts to the second server computing system:
generating one or more dummy contributions; and
inserting the dummy contributions into the modified ciphertexts.

7. The first server computing system of claim 6, wherein generating the one or more dummy contributions comprises:
sampling one or more frequency dummy contributions;
sampling one or more duplicate dummy contributions; and
sampling one or more blanket dummy contributions.

8. The first server computing system of claim 3, wherein the second server computing system has added noise to one or more of the set of aggregated values.

9. The first server computing system of claim 3, wherein the first sever system operations further comprise, after decrypting the set of aggregated values to generate the set of decrypted, aggregated values:
adding noise to one or more of the set of decrypted, aggregated values.

10. The first server computing system of claim 3, wherein the first sever system operations further comprise, after decrypting the set of aggregated values to generate the set of decrypted, aggregated values:
thresholding the set of decrypted, aggregated values, wherein thresholding the set of decrypted, aggregated values comprises removing one or more of the set of decrypted, aggregated values that is less than a threshold value.

11. The first server computing system of claim 3, wherein:
the set of aggregated values have been shuffled by the second server computing system; and
the first sever system operations further comprise, after decrypting the set of aggregated values to generate the set of decrypted, aggregated values:
transmitting the set of decrypted, aggregated values to the second server computing system for de-shuffling by the second server computing system.

12. The first server computing system of claim 3, wherein the first sever system operations further comprise, after decrypting the set of aggregated values to generate the set of decrypted, aggregated values:
receiving a non-zero index decryption list from the second server computing system; and
recovering a respective index associated with each entry on the non-zero index decryption list.

13. A second server computing system comprising one or more server computing devices, the second server computing system configured to perform second server system operations to enable private and secure multi-party computation, the second server system operations comprising:
receiving a plurality of modified ciphertexts from a first, different server computing system, each modified ciphertext comprising:
a pseudoindex generated by the first server computing system; and
a value that has been encrypted using both:
a public homomorphic encryption key associated with the first server computing system; and
an additional public key associated with the server computing system;
decrypting the respective value in each modified ciphertext using a private key associated with the additional public key to obtain a partially decrypted value for each ciphertext;
partitioning the modified ciphertexts based on the pseudoindices;
determining, for each pseudoindex and using homomorphic aggregation, an aggregated value to generate a set of aggregated values; and
transmitting the set of aggregated values to the first server computing system for the first server computing system to decrypt using a private homomorphic encryption key that corresponds to the public homomorphic encryption key.

14. The second server computing system of claim 13, wherein:
each modified ciphertext further comprises a respective index that has been encrypted using a combined public key generated from two or more private keys respectively separately held by the first server computing system and the second server computing system; and
the second server system operations further comprise:
using the respective private key separately held by the second server computing system to partially decrypt the respective index and generate a respective partially decrypted index; and
for at least one of the set of aggregated values, transmitting the corresponding partially decrypted index to the first server computing system for the first server computing system to use the respective private key separately held by the first server computing system to recover the original respective index from the partially decrypted index.

15. The second server computing system of claim 13, wherein:
each pseudoindex was generated by the first server computing system from a first ciphertext component using a hash function and key held by the first server computing system, the first ciphertext component comprising a hashed version of the index that has been encrypted using a semantic public key associated with the second server computing system; and
the second server system operations further comprise, prior to partitioning the modified ciphertexts based on the pseudoindex:
partially decrypting each pseudoindex using a semantic private key that corresponds to the semantic public key, wherein said partitioning is performed based on the partially decrypted pseudoindices.

16. The second server computing system of claim 13, wherein the second server system operations further comprise, prior to transmitting the set of aggregated values to the first server computing system:
adding noise to the set of aggregated values.

17. The second server computing system of claim 13, wherein the second server system operations further comprise, prior to transmitting the set of aggregated values to the first server computing system:
adding one or more dummy records to the set of aggregated values.

18. The second server computing system of claim 13, wherein the second server system operations further comprise:
shuffling the set of aggregated values prior to transmitting the set of aggregated values to the first server computing system;
receiving a set of decrypted, aggregated values from the first server computing system, the set of decrypted, aggregated values having an ordering that corresponds to the set of aggregated values; and
de-shuffling the set of decrypted, aggregated values.

19. The second server computing system of claim 13, wherein the second server system operations further comprise:
generating a non-zero index decryption list that indicates which partially decrypted indices have non-zero values; and
transmitting the non-zero index decryption list to the first server computing system.
